(19) United States
(12) Patent Application Publication
(10) Pub. No.: US 2010/0185571 A1
(43) Pub. Date: Jul. 22, 2010

(54) INFORMATION PROCESSING APPARATUS, INFORMATION PROCESSING METHOD, AND PROGRAM

(76) Inventor: Tsutomu SAWADA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/687,749

(22) Filed: Jan. 14, 2010

(30) Foreign Application Priority Data
Jan. 19, 2009 (JP) P2009-009116

(51) Int. Cl. G06F 15/18; G06N 5/02

(52) U.S. Cl. 706/12; 706/52

(57) ABSTRACT

An information processing apparatus includes a plurality of information input units inputting information including image information or sound information in a real space, an event detection unit analyzing input information from the information input units so as to generate event information including estimated position information and estimated identification information of users present in the real space, and an information integration processing unit setting hypothesis data regarding user existence and position information and user identification information of the users in the real space and updating and selecting hypothesis data based on the event information so as to generate analysis information including user existence and position information and user identification information of the users in the real space.

### BACKGROUND OF THE INVENTION

1. Field of the Invention

The present invention relates to an information processing apparatus, an information processing method, and a program. In particular, the present invention relates to an information processing apparatus, an information processing method, and a program for receiving input information, for example, information such as an image, sound, or the like, from the outside and performing analysis on an external environment based on the input information, for example, analysis of a person who is uttering words.

2. Description of the Related Art

A system that performs processing between a person and an information processing apparatus, such as a PC or a robot, for example, communication or interaction is called a man-machine interaction system. In this man-machine interaction system, the information processing apparatus, such as a PC or a robot, receives image information or sound information and performs analysis based on the input information so as to recognize actions of a person, for example, motions or words of the person.

When a person transmits information, the person utilizes not only words but also various channels, such as a sight line, an equation, and the like, as information transmission channels. If a machine can analyze all of such channels, communication between the person and the machine can reach the same level as communication between persons. An interface that performs analysis on input information from a plurality of such channels (also referred to as modalities or modals) is called a multi-modal interface, which has been developed and researched in recent years.

For example, when image information photographed by a camera or sound information acquired by a microphone is input or analyzed, to perform more detailed analysis, it is effective to input a large amount of information from a plurality of cameras and a plurality of microphones provided at various points.

As a specific system, for example, the following system is conceivable. A system can be realized in which an information processing apparatus (television) receives images and sound of users (father, mother, sister, and brother) in front of the television through a camera and a microphone, analyzes positions of the respective users and which of them utters a word. Then, the television performs processing based on analysis information, for example, zooming-in of the camera on a user who spoke or an appropriate response to the user who spoke.

Most of the general man-machine interaction systems of the related art deterministically integrate information from a plurality of channels (modals) and determine where a plurality of users are present, who the users are, and which of them utters a word. Examples of the related art that discloses such a system are Japanese Unexamined Patent Application Publication Nos. 2005-271137 and 2002-264051.

However, according to the deterministic integration processing method in the related art system using uncertain and asynchronous data input from the microphone or camera, robustness may be lacking and only data with low accuracy may be obtained. In an actual system, sensor information that can be obtained in an actual environment, that is, an input image from the camera or sound information input from the microphone is uncertain data including various kinds of extra information, for example, noise or unnecessary information. When image analysis or sound analysis is performed, it is important to efficiently integrate effective information from such sensor information.

### SUMMARY OF THE INVENTION

Therefore, it is desirable to provide, in a system that analyzes input information from a plurality of channels (modalities or modals), specifically, that performs processing for identifying persons around the system, an information processing apparatus, an information processing method, and a program for performing probabilistic processing on uncertain information in various kinds of input information, such as image and sound information to perform processing for integrating information into information estimated as high in accuracy, thereby improving robustness and performing analysis with high accuracy.

It is also desirable to provide an information processing apparatus, an information processing method, and a program for improving estimation performance of user identification and performing analysis with high accuracy by using estimation information concerning whether each target actually exists or not so as to probabilistically integrate uncertain and asynchronous position information and identification information having a plurality of modals and to estimate where a plurality of targets are present and who the targets are.

A first embodiment of the invention provides an information processing apparatus. The information processing apparatus includes a plurality of information input units inputting information including image information or sound information in a real space, an event detection unit analyzing input information from the information input units so as to generate event information including estimated position information and estimated identification information of users present in the real space, and an information integration processing unit setting hypothesis data regarding user existence and position information and user identification information of the users in the real space and updating and selecting hypothesis data based on the event information so as to generate analysis information including user existence and position information and user identification information of the users in the real space.

The information integration processing unit may input the event information generated by the event detection unit and may execute particle resampling processing, to which a plurality of particles set with a plurality of targets corresponding to virtual users, so as to generate the analysis information including the user existence and position information and the user identification information of the users in the real space.

The event detection unit may generate event information including user position information having a Gaussian distribution corresponding to event occurrence sources and user certainty factor information as user identification information corresponding to the event occurrence sources. The information integration processing unit may hold a plurality of particles set with a plurality of targets having (1) target existence hypothesis information for calculating existence probabilities of the targets, (2) probability distribution information of existence positions of the targets, and (3) user certainty factor information indicating who the targets are as target data for each of a plurality of targets corresponding to virtual users, may set target hypotheses corresponding to the event occurrence sources in the respective particles, may calculate as particle weights event-target likelihoods that are similarities between target data corresponding to the target hypotheses of the respective particles and input event information so as to execute resampling processing of the particles in response to the calculated particle weights, and may execute particle update processing including target data update for approximating target data corresponding to the target hypotheses of the respective particles to the input event information.

The information integration processing unit may set as target data of the respective targets a hypothesis (c=1) with a target or a hypothesis (c=0) with no target that is the target existence hypothesis, and may calculate a target existence probability [PtID(c=1)] by the following equation using the particles after the resampling processing. [PtID(c=1)]={number of targets of the same target identifier allocated with c=1}/{number of particles}

The information integration processing unit may set at least one target generation candidate for the respective particles, may compare a target existence probability of the target generation candidate with a threshold value set in advance, and when the target existence probability of the target generation candidate is larger than the threshold value, may perform processing for setting the target generation candidate as a new target.

The information integration processing unit may execute processing for multiplying the event-target likelihood by a coefficient smaller than 1 so as to calculate the particle weight for a particle, in which the target generation candidate is set as the target hypothesis, at the time of the calculation processing of the particle weights.

The information integration processing unit may compare a target existence probability of each target set in the respective particles with a threshold value for deletion set in advance, and when the target existence probability is smaller than the threshold value for deletion, may perform processing for deleting the relevant target.

The information integration processing unit may execute update processing for probabilistically changing the target existence hypothesis from existence (c=1) to non-existence (c=0) on the basis of a time length for which update to the event information input from the event detection unit is not made, after the update processing, may compare a target existence probability of each target set in the respective particles with a threshold value for deletion set in advance, and when the target existence probability is smaller than the threshold value for deletion, may perform processing for deleting the relevant target.

The information integration processing unit may execute setting processing of the target hypotheses corresponding to the event occurrence sources in the respective particles under the following restrictions:
(restriction 1) a target in which a hypothesis of target existence is c=0 (non-existence) is not set as an event occurrence source,
(restriction 2) the same target is set as an event occurrence source for different events, and
(restriction 3) when the condition “(number of events)>(number of targets)” is established at the same time, events more than the number of targets are determined to be noise.

The information integration processing unit may update a joint probability of candidate data of the users associated with the targets on the basis of the user identification information included in the event information, and may execute processing for calculating user certainty factors corresponding to the targets using the value of the updated joint probability.

The information integration processing unit may marginalize the value of the joint probability updated on the basis of the user identification information included in the event information so as to calculate certainty factors of user identifiers corresponding to the respective targets.

The information integration processing unit may perform initial setting of the joint probability of candidate data of the users associated with the targets under a restriction that the same user identifier (UserID) is not allocated to a plurality of targets, and may perform initial setting of a probability value such that the probability value of a joint probability P(Xu) of candidate data set with the same user identifier (UserID) for different targets is set to P(Xu)=0.0, and the probability of other target data is set to P(Xu)=0.0<P≦1.0.

A second embodiment of the invention provides an information processing method of executing information analysis processing in an information processing apparatus. The information processing method includes the steps of inputting information including image information or sound information in a real space by a plurality of information input units, generating event information including estimated position information and estimated identification information of users present in the real space by an event detection unit through analysis of the information input in the step of inputting the information, and setting hypothesis data regarding user existence and position information and user identification information of the users in the real space and updating and selecting hypothesis data based on the event information by an information integration processing unit so as to generate analysis information including user existence and position information and user identification information of the users in the real space.

A third embodiment of the invention provides a program for causing an information processing apparatus to execute information analysis processing. The program includes the steps of inputting information including image information or sound information in a real space by a plurality of information input units, generating event information including estimated position information and estimated identification information of users present in the real space by an event detection unit through analysis of the information input in the step of inputting the information, and setting hypothesis data regarding user existence and position information and user identification information of the users in the real space and updating and selecting hypothesis data based on the event information by an information integration processing unit so as to generate analysis information including user existence and position information and user identification information of the users in the real space.

The program according to the embodiment of the invention is, for example, a program that can be provided to an information processing apparatus or a computer system, which can execute various program codes, through a storage medium in a computer-readable format or a communication medium. With such a program in a computer-readable format, processing corresponding to the program is realized on the information processing apparatus or the computer system.

Other objects, features, and advantages of the invention will be apparent from a more detailed description based on embodiments of the invention described below and the accompanying drawings. In this specification, a system has a configuration of a logical set of a plurality of apparatuses and is not limited to a system in which apparatuses having individual configurations are provided in an identical housing.

According to the embodiments of the invention, analysis information including user existence and position information and user identification information of users in a real space is generated on the basis of image information or sound information acquired by a camera or a microphone. For each of a plurality of targets corresponding to virtual users, user certainty factor information is set which indicates (1) target existence hypothesis information for calculating existence probabilities of the targets, (2) probability distribution information of existence positions of targets, (3) who the targets are, and an existence probability of each target is calculated using the target existence hypothesis information so as to execute setting of a new target and target deletion. Therefore, it is possible to delete a target that is erroneously generated due to erroneous detection and to execute user identification processing with high accuracy and high efficiency.

### BRIEF DESCRIPTION OF THE DRAWINGS

FIG. 1 is a diagram illustrating an overview of processing executed by an information processing apparatus according to an embodiment of the invention.

FIG. 2 is a diagram illustrating the configuration and processing of the information processing apparatus according to the embodiment of the invention.

FIGS. 3A and 3B are diagrams illustrating an example of information generated and input to a sound/image integration processing unit 131 by a sound event detection unit 122 and an image event detection unit 112.

FIGS. 4A to 4C are diagrams illustrating a basic processing example to which a particle filter is applied.

FIG. 5 is a diagram illustrating the configuration of particles set in this processing example.

FIG. 6 is a diagram illustrating the configuration of target data of respective targets included in the respective particles.

FIG. 7 is a flowchart illustrating a processing sequence executed by the sound/image integration processing unit 131.

FIG. 8 is a diagram illustrating details of processing for calculating a target weight [W_{tID}].

FIG. 9 is a diagram illustrating details of processing for calculating a particle weight [W_{pID}].

FIG. 10 is a diagram illustrating details of processing for calculating the particle weight [W_{pID}].

FIG. 11 is a diagram illustrating a particle setting example and target information when user position and user identification processing is executed using estimation information of existence probabilities of targets.

FIG. 12 is a diagram showing an example of target data when the user position and user identification processing is executed using the estimation information of the existence probabilities of the targets.

FIGS. 13A to 13C are flowcharts illustrating a processing sequence executed by the sound/image integration processing unit in the information processing apparatus according to the embodiment of the invention.

FIG. 14 is a diagram illustrating a processing example when processing for setting a hypothesis of an event occurrence sources and setting the particle weight is executed.

FIG. 15 is a diagram showing an initial state setting example under a restriction that “the same user identifier (UserID) is not allocated to a plurality of targets” when the number of targets n=3 (0 to 2), and the number of registered users k=3 (0 to 2).

FIGS. 16A to 16C are diagrams illustrating an analysis processing example according to an embodiment of the invention where inter-target independence is excluded under the restriction that “the same user identifier (UserID) is not allocated to a plurality of targets”.

FIGS. 17A to 17C are diagrams illustrating a marginalization result obtained by the processing shown in FIG. 16.

FIG. 18 is a diagram illustrating a data deletion processing example for deleting from target data a state where any repeated xu (user identifier (UserID)) exists.

FIG. 19 is a diagram illustrating a processing example when a target allocated as tID=can is newly generated and added relative to two targets allocated as tID=1 and 2.

FIG. 20 is a diagram illustrating a processing example when a target allocated as tID=0 is deleted from among three targets allocated as tID=0, 1, and 2.

### DESCRIPTION OF THE PREFERRED EMBODIMENTS

Details of an information processing apparatus, an information processing method, and a program according to an embodiment of the invention will be hereinafter described with reference to the accompanying drawings. The invention is an improvement of the configuration described in Japanese Patent Application No. 2007-193930, which is an earlier application by the same applicant, thereby realizing improvement in analysis performance.

The invention will be hereinafter described in order of the following items.
(1) User position and user identification processing by hypothesis update based on event information input
(2) User position and user identification processing using estimation information of existence probabilities of targets
(2-1) Overview of user position and user identification processing using estimation information of existence probabilities of targets
(2-2) Hypothesis update process of target existence by event
(2-3) Target generation process
(2-4) Target deletion process

The item (1) is substantially the same as described in Japanese Patent Application No. 2007-193930. In this specification, in the item (1), the overall configuration of user position and user identification processing as the premise of the invention will be described with reference to the configuration described in Japanese Patent Application No. 2007-193930, and in the item (2), the details of the configuration which is the feature of the invention will be subsequently described.

### [(1) User Position and User Identification Processing by Hypothesis Update Based on Event Information Input]

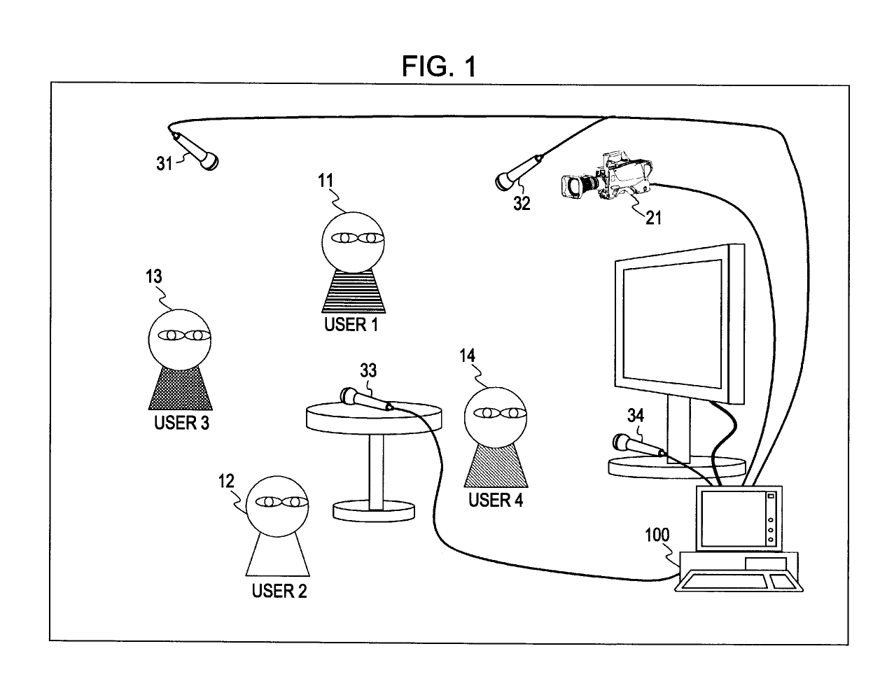

First, an overview of processing executed by the information processing apparatus according to the embodiment of the invention will be described with reference to FIG. 1. An information processing apparatus 100 of this embodiment receives image information and sound information from sensors which input environmental information, for example, a camera 21 and a plurality of microphones 31 to 34, and performs analysis of an environment on the basis of the input information. Specifically, the information processing apparatus 100 performs analysis of positions of a plurality of users 1 to 4 (11 to 14) and identification of the users present at the positions.

In the example shown in the drawing, for example, when the users 1 to 4 (11 to 14) are a father, a mother, a sister, and a brother of a family, the information processing apparatus 100 performs analysis of image information and sound information input from the camera 21 and the plurality of microphones 31 to 34 and identifies positions where the four users 1 to 4 are present and which of the father, the mother, the sister, and the brother are the users at the respective positions. An identification processing result is used for various kinds of processing, for example, processing for zooming-in of a camera on a user who spoke and a response from a television to the user who spoke.

Main processing of the information processing apparatus 100 according to this embodiment is to perform user identification processing as processing for identifying positions of users and identifying the users on the basis of input information from a plurality of information input units (the camera 21 and the microphones 31 to 34). Processing for using an identification result is not particularly limited. Various kinds of uncertain information are included in the image information or the sound information input from the camera 21 or the plurality of microphones 31 to 34. The information processing apparatus 100 of this embodiment performs probabilistic processing on the uncertain information included in these kinds of input information and performs processing for integrating the input information into information estimated as high in accuracy. With this estimation processing, robustness is improved, and analysis is performed with high accuracy.

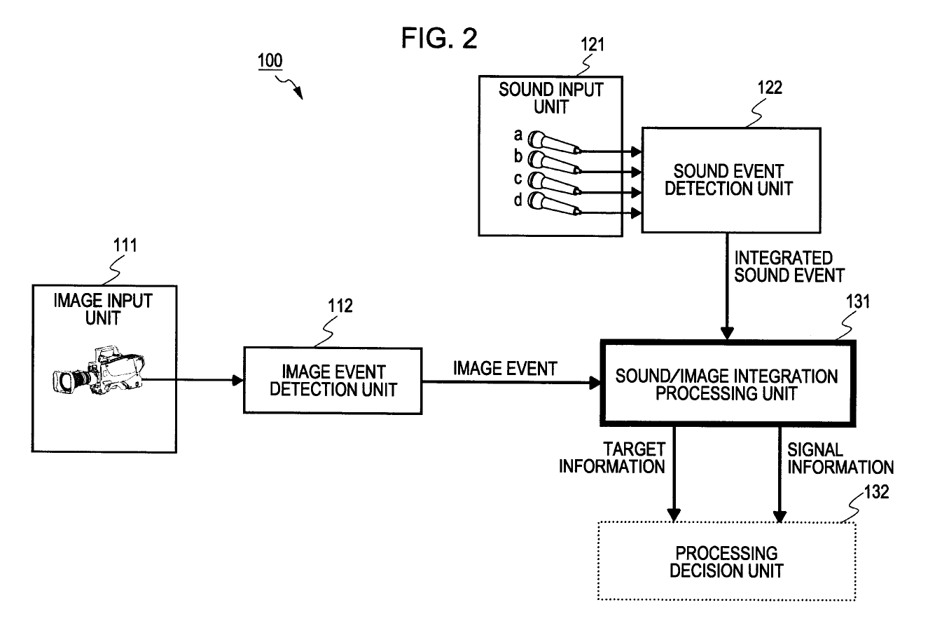

FIG. 2 shows an example of the configuration of the information processing apparatus 100. The information processing apparatus 100 has an image input unit (camera) 111 and a plurality of sound input units (microphones) 121a to 121d as input devices. Image information is input from the image input unit (camera) 111 and sound information is input from the sound input units (microphones) 121. The information processing apparatus 100 performs analysis on the basis of these kinds of input information. The plurality of sound input units (microphones) 121a to 121d are arranged at various positions, as shown in FIG. 1.

The sound information input from the plurality of microphones 121a to 121d is input to a sound/image integration processing unit 131 through a sound event detection unit 122. The sound event detection unit 122 analyzes and integrates the sound information input from the plurality of sound inputting units (microphones) 121a to 121d arranged at a plurality of different positions. Specifically, the sound event detection unit 122 generates, on the basis of the sound information input from the sound input units (microphones) 121a to 121d, user identification information indicating a position of generated sound and which of the users generated the sound, and inputs the user identification information to the sound/image integration processing unit 131.

Specific processing executed by the information processing apparatus 100 is, for example, processing for identifying which of the users 1 to 4 spoke at which position in an environment in which a plurality of users are present as shown in FIG. 1, that is, performing user position and user identification and processing for specifying an event occurrence source, such as a person who uttered sound.

The sound event detection unit 122 analyzes the sound information input from the plurality of sound input units (microphones) 121a to 121d arranged at a plurality of different positions and generates position information of sound generation sources as probability distribution data. Specifically, the sound event detection unit 122 generates expected values and variance data N(mₑ,σₑ) concerning sound source directions. The sound event detection unit 122 generates user identification information on the basis of comparison processing with characteristic information of user sound registered in advance. The identification information is also generated as a probabilistic estimated value. Characteristic information concerning sound of a plurality of users, which should be verified, is registered in advance in the sound event detection unit 122. The sound event detection unit 122 executes comparison processing of input sound and registered sound, performs processing for determining which user's sound the input sound is with a high probability, and calculates posterior probabilities or scores for all the registered users.

In this way, the sound event detection unit 122 analyzes the sound information input from the plurality of sound input units (microphones) 121a to 121d arranged at a plurality of different positions, generates integrated sound event information from the probability distribution data generated from the position information of sound generation sources and the user identification information including the probabilistic estimated value, and inputs the integrated sound event information to the sound/image integration processing unit 131.

On the other hand, the image information input from the image input unit (camera) 111 is input to the sound/image integration processing unit 131 through the image event detection unit 112. The image event detection unit 112 analyzes the image information input from the image input unit (camera) 111, extracts faces of people included in the image, and generates position information of the faces as probability distribution data. Specifically, the image event detection unit 112 generates expected values and variance data N(mₑ,σₑ) concerning positions and directions of the faces. The image event detection unit 112 generates user identification information on the basis of comparison processing with characteristic information of user faces registered in advance. The identification information is also generated as a probabilistic estimated value. Characteristic information concerning faces of a plurality of users, which should be verified, is registered in advance in the image event detection unit 112. The image event detection unit 112 executes comparison processing of characteristic information of an image of a face area extracted from an input image and the registered characteristic information of face images, performs processing for determining with a high probability which user's face corresponds to the image of the face area, and calculates posterior probabilities or scores for all the registered users.

A technique in the related art is applied to the sound identification, face detection, and face identification processing executed by the sound event detection unit 122 and the image event detection unit 112. For example, the techniques described in the following documents can be applied as the face detection and face identification processing:

Kotaro Sabe and Kenichi Hidai, “Learning of an Actual Time Arbitrary Posture and Face Detector Using a Pixel Difference Characteristic”, Tenth Image Sensing Symposium Lecture Proceedings, pp. 547 to 552, 2004; and

Japanese Unexamined Patent Application Publication No. 2004-302644 [Title of the Invention: Face Identification Apparatus, Face Identification Method, Recording Medium, and Robot Apparatus].

The sound/image integration processing unit 131 executes processing for probabilistically estimating, on the basis of the input information from the sound event detection unit 122 or the image event detection unit 112, where a plurality of users are present, who the users are, and who uttered a signal, such as sound or the like. This processing will be described below in detail. The sound/image integration processing unit 131 outputs, on the basis of the input information from the sound event detection unit 122 or the image event detection unit 112, the following information to a processing decision unit 132:

(a) [target information] as estimation information indicating where a plurality of users are present and who the users are; and

(b) [signal information] indicating an event occurrence source such as a user who spoke.

The processing decision unit 132 that receives results of this kind of identification processing executes processing using the identification processing results. For example, the processing decision unit 132 performs processing, such as zooming-in of a camera on a user who spoke and a response from a television to the user who spoke.

As described above, the sound event detection unit 122 generates position information of sound generation sources as probability distribution data. Specifically, the sound event detection unit 122 generates expected values and variance data N(mₑ,σₑ) concerning sound source directions. The sound event detection unit 122 generates user identification information on the basis of comparison processing with characteristic information of user sound registered in advance and inputs the user identification information to the sound/image integration processing unit 131. The image event detection unit 112 extracts faces of people included in an image and generates position information of the faces as probability distribution data. Specifically, the image event detection unit 112 generates expected values and variance data N(mₑ,σₑ) concerning positions and directions of the faces. The image event detection unit 112 generates user identification information on the basis of comparison processing with characteristic information of user faces registered in advance and inputs the user identification information to the sound/image integration processing unit 131.

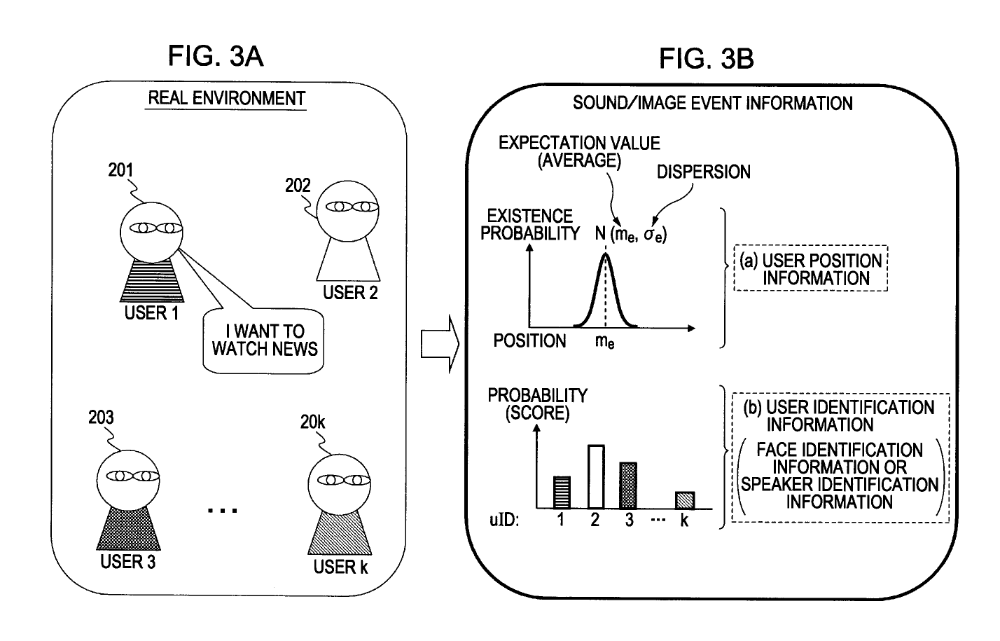

An example of information generated and input to the sound/image integration processing unit 131 by the sound event detection unit 122 or the image event detection unit 112 will be described with reference to FIGS. 3A and 3B. FIG. 3A shows an example of an actual environment including a camera and microphones the same as the actual environment described with reference to FIG. 1. A plurality of users 1 to k (201 to 20k) are present in the actual environment. In this environment, when a certain user speaks, sound is input through a microphone. The camera is continuously photographing images.

The information generated and input to the sound/image integration processing unit 131 by the sound event detection unit 122 and the image event detection unit 112 is basically the same information and includes two kinds of information shown in FIG. 3B, that is, (a) user position information and (b) user identification information (face identification information or speaker identification information). These two kinds of information are generated every time an event occurs. When sound information is input from the sound input units (microphones) 121a to 121d, the sound event detection unit 122 generates (a) user position information and (b) user identification information on the basis of the sound information and inputs the information to the sound/image integration processing unit 131. The image event detection unit 112 generates, for example, at a fixed frame interval set in advance, (a) user position information and (b) user identification information on the basis of image information input from the image input unit (camera) 111 and inputs the information to the sound/image integration processing unit 131. In this example, one camera is set as the image input unit (camera) 111. Images of a plurality of users are photographed by one camera. In this case, the image event detection unit 112 generates (a) user position information and (b) user identification information for each of a plurality of faces included in one image and inputs the information to the sound/image integration processing unit 131.

Processing by the sound event detection unit 122 for generating (a) user position information and (b) user identification information (speaker identification information) on the basis of sound information input from the sound input units (microphones) 121a to 121d will be described.

### Processing for Generating (a) User Position Information by Sound Event Detection Unit 122

The sound event detection unit 122 generates, on the basis of sound information input from the sound input units (microphones) 121a to 121d, estimation information concerning a position of a user who uttered analyzed sound, that is, a speaker. In other words, the sound event detection unit 122 generates positions where the speaker is estimated to be present as Gaussian distribution (normal distribution) data N(mₑ,σₑ) including an expected value (average) [mₑ] and variance information [σₑ].

### Processing for Generating (b) User Identification Information (Speaker Identification Information) by Sound Event Detection Unit 122

The sound event detection unit 122 estimates who a speaker is on the basis of sound information input from the sound input units (microphones) 121a to 121d through comparison processing of input sound and characteristic information of sound of the users 1 to k registered in advance. Specifically, the sound event detection unit 122 calculates probabilities that the speaker is the respective users 1 to k. Values calculated by the calculation are set as (b) user identification information (speaker identification information). For example, the sound event detection unit 122 generates data set with probabilities that the speaker is the respective users through processing for allocating a highest score to a user having a registered sound characteristic closest to a characteristic of the input sound and allocating a lowest score (for example, 0) to a user having a sound characteristic most different from the characteristic of the input sound and sets the data as (b) user identification information (speaker identification information).

Processing by the image event detection unit 112 for generating (a) user position information and (b) user identification information (face identification information) on the basis of image information input from the image input unit (camera) 111 will be described.

### Processing for Generating (a) User Position Information by Image Event Detection Unit 112

The image event detection unit 112 generates estimation information concerning positions of faces for respective faces included in image information input from the image input unit (camera) 111. In other words, the image event detection unit 112 generates positions where faces detected from an image are estimated to be present as Gaussian distribution (normal distribution) data N(mₑ,σₑ) including an expected value (average) [mₑ] and variance information [σₑ].

### Processing for Generating (b) User Identification Information (Face Identification Information) by Image Event Detection Unit 112

The image event detection unit 112 detects, on the basis of image information input from the image input unit (camera) 111, faces included in the image information and estimates whose face the respective faces are through comparison processing of the input image information and characteristic information of faces of the users 1 to k registered in advance. Specifically, the image event detection unit 112 calculates probabilities that the extracted respective faces are the respective users 1 to k. Values calculated by the calculation are set as (b) user identification information (face identification information). For example, the image event detection unit 112 generates data set with probabilities that the faces are the respective users through processing for allocating a highest score to a user having a registered face characteristic closest to a characteristic of a face included in an input image and allocating a lowest score (for example, 0) to a user having a face characteristic most different from the characteristic of the face included in the input image and sets the data as (b) user identification information (face identification information).

When a plurality of faces are detected from a photographed image of the camera, the image event detection unit 112 generates (a) user position information and (b) user identification information (face identification information) in response to the respective detected faces and inputs the information to the sound/image integration processing unit 131.

In this example, one camera is used as the image input unit 111. However, photographed images of a plurality of cameras may be used. In this case, the image event detection unit 112 generates (a) user position information and (b) user identification information (face identification information) for respective faces included in the respective photographed images of the respective cameras and inputs the information to the sound/image integration processing unit 131.

Processing executed by the sound/image integration processing unit 131 will be described. As described above, the sound/image integration processing unit 131 sequentially receives the two kinds of information shown in FIG. 3B, that is, (a) user position information and (b) user identification information (face identification information or speaker identification information) from the sound event detection unit 122 or the image event detection unit 112. As input timing for these kinds of information, various settings are possible. For example, in a possible setting, the sound event detection unit 122 generates and inputs the respective kinds of information (a) and (b) as sound event information when new sound is input, and the image event detection unit 112 generates and inputs the respective kinds of information (a) and (b) as image event information in fixed frame period units.

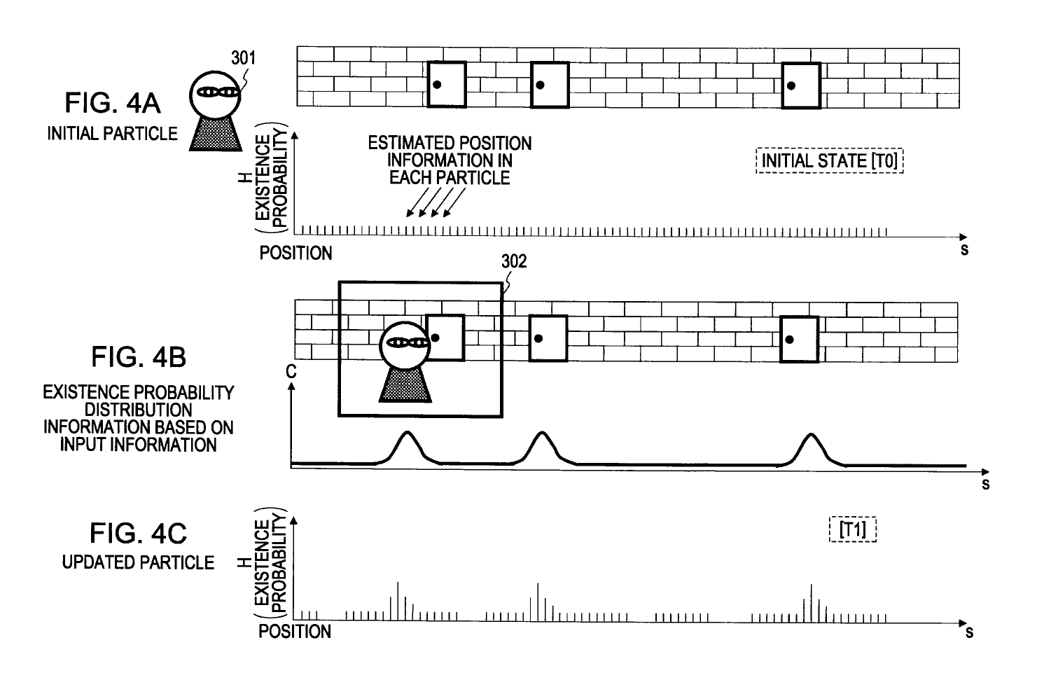

Processing executed by the sound/image integration processing unit 131 will be described with reference to FIGS. 4A to 4C and subsequent drawings. The sound/image integration processing unit 131 sets probability distribution data of hypotheses concerning position and identification information of users and updates the hypotheses on the basis of input information so as to perform processing for leaving only more likely hypotheses. As a method of this processing, the sound/image integration processing unit 131 executes processing to which a particle filter is applied.

The processing to which the particle filter is applied is processing for setting a large number of particles corresponding to various hypotheses, in this example, hypotheses concerning positions and identities of users and increasing weights of more likely particles on the basis of the two kinds of information shown in FIG. 3B, that is, (a) user position information and (b) user identification information (face identification information or speaker identification information) input from the sound event detection unit 122 or the image event detection unit 112.

An example of basic processing to which the particle filter is applied will be described with reference to FIGS. 4A to 4C. For example, the example shown in FIGS. 4A to 4C indicates an example of processing for estimating an existence position corresponding to a certain user using the particle filter. The example shown in FIGS. 4A to 4C is processing for estimating a position where a user 301 is present in a one-dimensional area on a certain straight line.

An initial hypothesis (H) is uniform particle distribution data as shown in FIG. 4A. Then, image data 302 is acquired and existence probability distribution data of the user 301 based on an acquired image is acquired as data shown in FIG. 4B. The particle distribution data shown in FIG. 4A is updated on the basis of the probability distribution data based on the acquired image. Updated hypothesis probability distribution data shown in FIG. 4C is obtained. Such processing is repeatedly executed on the basis of input information to obtain more likely position information of the user.

Details of the processing using the particle filter are described in, for example, [D. Schulz, D. Fox, and J. Hightower, People Tracking with Anonymous and ID-sensors Using Rao-Blackwellised Particle Filters, Proc. of the International Joint Conference on Artificial Intelligence (IJCAI-03)].

The processing example shown in FIGS. 4A to 4C is described as a processing example where input information is only image data only for an existence position of the user 301. Respective particles have information concerning only the existence position of the user 301.

On the other hand, the processing according to this embodiment is processing for discriminating positions of a plurality of users and who the plurality of users are on the basis of the two kinds of information shown in FIG. 3B, that is, (a) user position information and (b) user identification information (face identification information or speaker identification information) input from the sound event detection unit 122 or the image event detection unit 112. Therefore, in the processing to which the particle filter is applied in this embodiment, the sound/image integration processing unit 131 sets a large number of particles corresponding to hypotheses concerning positions of users and who the users are and updates particles on the basis of the two kinds of information shown in FIG. 3B input from the sound event detection unit 122 or the image event detection unit 112.

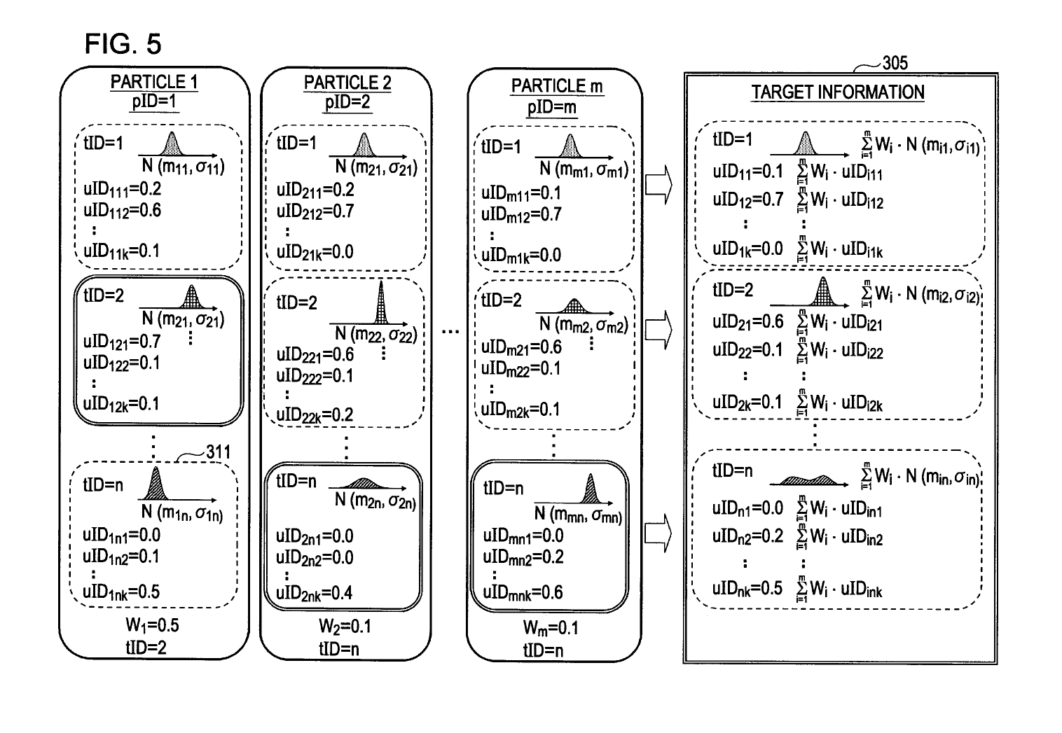

The configuration of particles set in this processing example will be described with reference to FIG. 5. The sound/image integration processing unit 131 has m (a number set in advance) particles, that is, particles 1 to m shown in FIG. 5. Particle IDs (pID=1 to m) as identifiers are set for the respective particles.

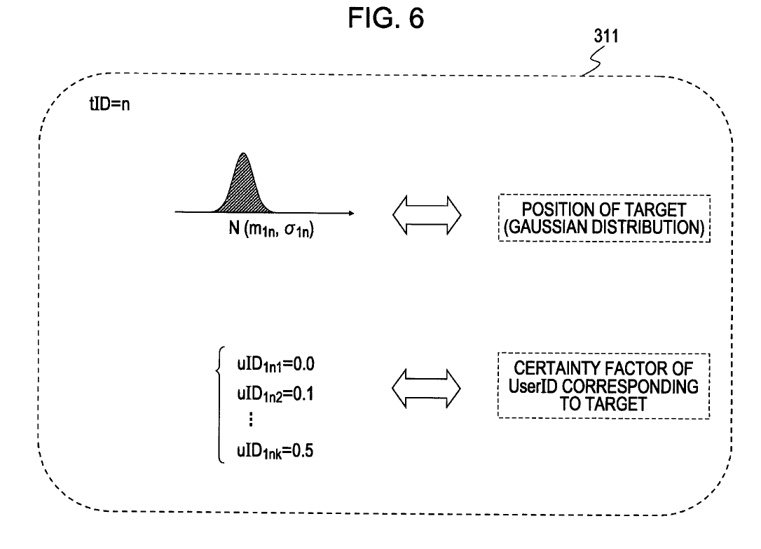

A plurality of targets corresponding to virtual objects corresponding to positions and objects to be identified are set for the respective particles. In this example, for example, a plurality of targets corresponding to virtual users equal to or lager in number than a number estimated as being present in a real space are set for the respective particles. In the respective m particles, data equivalent to the number of targets are held in target units. In the example shown in FIG. 5, n targets are included in one particle. The configuration of target data of the respective targets included in the respective particles is shown in FIG. 6.

The respective target data included in the respective particles will be described with reference to FIG. 6. FIG. 6 shows the configuration of target data of one target (target ID: tID=n) 311 included in the particle 1 (pID=1) shown in FIG. 5. The target data of the target 311 includes the following data as shown in FIG. 6:

(a) a probability distribution [Gaussian distribution: N(m₁ₙ,σ₁ₙ)] of existence positions corresponding to the respective targets; and

(b) user certainty factor information (uID) indicating who the respective targets are, that is, uID₁ₙ₁=0.0, uID₁ₙ₂=0.1, . . . , and uID₁ₙₖ=0.5.

(1n) [m₁ₙ,σ₁ₙ] in the Gaussian distribution: N(m₁ₙ,σ₁ₙ) described in (a) means a Gaussian distribution as an existence probability distribution corresponding to a target ID: tID=n in a particle ID: pID=1.

(1n1) included in [uID₁ₙ₁] in the user certainty factor information (uID) described in (b) means a probability that a user with a target ID: tID=n in a particle ID: pID=1 is a user 1. In other words, data with a target ID=n means that a probability that the user is a user 1 is 0.0, a probability that the user is a user 2 is 0.1, . . . , and a probability that the user is a user k is 0.5.

Referring back to FIG. 5, description of the particles set by the sound/image integration processing unit 131 will be continued. As shown in FIG. 5, the sound/image integration processing unit 131 sets m (the number set in advance) particles (pID=1 to m). The respective particles have, for respective targets (tID=1 to n) estimated as being present in the real space, target data of (a) a probability distribution [Gaussian distribution: N(m,σ)] of existence positions corresponding to the respective targets; and (b) user certainty factor information (uID) indicating who the respective targets are.

The sound/image integration processing unit 131 receives the event information shown in FIG. 3B, that is, (a) user position information and (b) user identification information (face identification information or speaker identification information) from the sound event detection unit 122 or the image event detection unit 112 and performs processing for updating the m particles (pID=1 to m).

The sound/image integration processing unit 131 executes the processing for updating the particles, generates (a) target information as estimation information indicating where a plurality of users are present and who the users are and (b) signal information indicating an event occurrence source such as a user who spoke, and outputs the information to the processing decision unit 132.

As shown in target information 305 at a right end in FIG. 5, the [target information] is generated as weighted sum data of data corresponding to the respective targets (tID=1 to n) included in the respective particles (pID=1 to m). Weights of the respective particles will be described below.

The target information 305 is information indicating (a) existence positions of targets (tID=1 to n) corresponding to virtual users set in advance by the sound/image integration processing unit 131 and (b) who the targets are (which one of uID1 to uIDk the targets are). The target information is sequentially updated according to the update of the particles. For example, when the users 1 to k do not move in the actual environment, the respective users 1 to k converge as data corresponding to k targets selected out of the n targets (tID=1 to n).

For example, user certainty factor information (uID) included in data of a target 1 (tID=1) at the top in the target information 305 shown in FIG. 5 has a highest probability concerning the user 2 (uID₁₂=0.7). Therefore, the data of the target 1 (tID=1) is estimated as corresponding to the user 2. (12) in (uID₁₂) in the data [uID₁₂=0.7] indicating the user certainty factor information (uID) indicates a probability corresponding to the user certainty factor information (uID) of the user 2 with the target ID=1.

The data of the target 1 (tID=1) at the top in the target information 305 corresponds to the user 2 with a highest probability. An existence position of the user 2 is estimated as being within a range indicated by existence probability distribution data included in the data of the target 1 (tID=1) at the top in the target information 305.

In this way, the target information 305 indicates, concerning the respective targets (tID=1 to n) initially set as virtual objects (virtual users), respective kinds of information of (a) existence positions of the targets and (b) who the targets are (which one of uID1 to uIDk the targets are). Therefore, respective k pieces of target information of the respective targets (tID=1 to n) converge to correspond to the users 1 to k when the users do not move.

When the number of targets (tID=1 to n) is larger than the number of users k, there are targets that do not correspond to any users. For example, in a target (tID=n) at the bottom in the target information 305, the user certainty factor information (uID) is 0.5 at the maximum and the existence probability distribution data does not have a large peak. It is determined that such data is not data corresponding to a specific user. Processing for deleting such a target may be performed. The processing for deleting a target is described below.

As described above, the sound/image integration processing unit 131 executes the processing for updating the particles on the basis of input information, generates (a) target information as estimation information indicating where a plurality of users are present, respectively, and who the users are and (b) signal information indicating an event occurrence source such as a user who spoke, and outputs the information to the processing decision unit 132.

The target information is the information described with reference to the target information 305 shown in FIG. 5. In addition to the target information, the sound/image integration processing unit 131 generates signal information indicating an event occurrence source such as a user who spoke and outputs the signal information. The signal information indicating the event occurrence source is, concerning a sound event, data indicating who spoke, that is, a speaker and, concerning an image event, data indicating whose face corresponds to a face included in an image. In this example, as a result, the signal information in the case of the image event coincides with signal information obtained from the user certainty factor information (uID) of the target information.

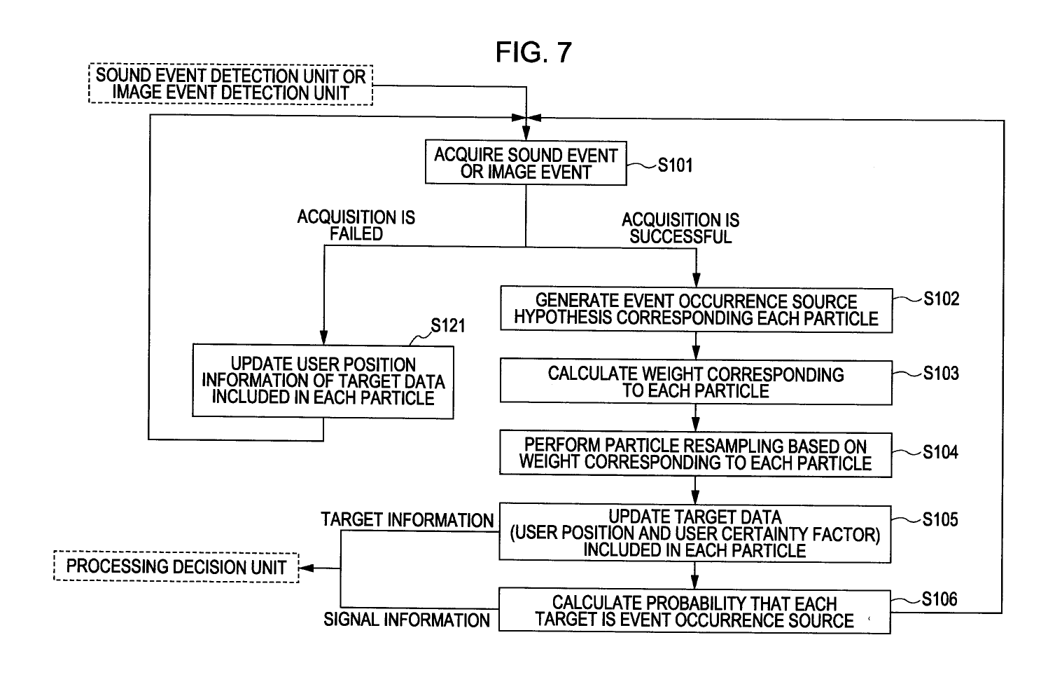

As described above, the sound/image integration processing unit 131 receives the event information shown in FIG. 3B, that is, user position information and user identification information (face identification information or speaker identification information) from the sound event detection unit 122 or the image event detection unit 112, generates (a) target information as estimation information indicating where a plurality of users are present and who the users are and (b) signal information indicating an event occurrence source such as a user who spoke, and outputs the information to the processing decision unit 132. This processing will be described below with reference to FIG. 7 and subsequent drawings.

FIG. 7 is a flowchart illustrating a processing sequence executed by the sound/image integration processing unit 131. First, in Step S101, the sound/image integration processing unit 131 receives the event information shown in FIG. 3B, that is, user position information and user identification information (face identification information or speaker identification information) from the sound event detection unit 122 or the image event detection unit 112.

If acquisition of the event information is successful, the sound/image integration processing unit 131 progresses to Step S102. If acquisition of the event information has failed, the sound/image integration processing unit 131 progresses to Step S121. Processing in Step S121 will be described below.

If acquisition of the event information is successful, the sound/image integration processing unit 131 performs particle update processing based on the input information in Step S102 and subsequent steps. Before the particle update processing, in Step S102, the sound/image integration processing unit 131 sets hypotheses of an event occurrence source in the respective m particles (pID=1 to m) shown in FIG. 5. The event occurrence source is, for example, in the case of a sound event, a user who spoke and, in the case of an image event, a user who has an extracted face.

In the example shown in FIG. 5, hypothesis data (tID=xx) of an event occurrence source is shown at the bottom of the respective particles. In the example shown in FIG. 5, hypotheses indicating which of the targets 1 to n is the event occurrence source are set for the respective particles in such a manner as tID=2 for the particle 1 (pID=1), tID=n for the particle 2 (pID=2), . . . , and tID=n for the particle m (pID=m). In the example shown in FIG. 5, target data of the event occurrence source set as the hypotheses are surrounded by double lines and indicated for the respective particles.

The setting of hypotheses of an event occurrence source is executed every time the particle update processing based on an input event is performed. In other words, the sound/image integration processing unit 131 sets hypotheses of an event occurrence source for the respective particles 1 to m. Under the hypotheses, the sound/image integration processing unit 131 receives the event information shown in FIG. 3B, that is, (a) user position information and (b) user identification information (face identification information or speaker identification information) as an event from the sound event detection unit 122 or the image event detection unit 112 and performs processing for updating the m particles (pID=1 to m).

When the particle update processing is performed, the hypotheses of an event occurrence source set for the respective particles 1 to m are reset and new hypotheses are set for the respective particles 1 to m. As a form of setting hypotheses, it is possible to adopt any one of methods of (1) random setting and (2) setting according to an internal model of the sound/image integration processing unit 131. The number of particles m is set larger than the number n of targets. Therefore, a plurality of particles are set in hypotheses in which an identical target is an event occurrence source. For example, when the number of targets n is 10, for example, processing with the number of particles m set to about 100 to 1000 is performed.

A specific processing example of the processing for (2) setting hypotheses according to an internal model of the sound/image integration processing unit 131 will be described.

First, the sound/image integration processing unit 131 calculates weights [W_{tID}] of the respective targets by comparing the event information acquired from the sound event detection unit 122 or the image event detection unit 112, for example, the two kinds of information shown in FIG. 3B, that is, (a) user position information and (b) user identification information (face identification information or speaker identification information) and data of targets included in particles held by the sound/image integration processing unit 131. The sound/image integration processing unit 131 sets hypotheses of an event occurrence source for the respective particles (pID=1 to m) on the basis of the calculated weights [W_{tID}] of the respective targets. The specific processing example will be described below.

In an initial state, hypotheses of an event occurrence source set for the respective particles (pID=1 to m) are set equally. In other words, when m particles (pID=1 to m) having the n targets (tID=1 to n) are set, initial hypothesis targets (tID=1 to n) of an event occurrence source set for the respective particles (pID=1 to m) are set to be equally allocated in such a manner that m/n particles are particles having the target 1 (tID=1) as an event occurrence source, m/n particles are particles having the target 2 (tID=2) as an event occurrence source, . . . , and m/n particles are particles having the target n (tID=n) as an event occurrence source.

In Step S101 shown in FIG. 7, the sound/image integration processing unit 131 acquires the event information, for example, the two kinds of information shown in FIG. 3B, that is, (a) user position information and (b) user identification information (face identification information or speaker identification information) from the sound event detection unit 122 or the image event detection unit 112. When acquisition of the event information is successful, in Step S102, the sound/image integration processing unit 131 sets hypothesis targets (tID=1 to n) of an event occurrence source for the respective m particles (pID=1 to m).

Details of the setting of hypothesis targets corresponding to the particles in Step S102 will be described. First, the sound/image integration processing unit 131 compares the event information input in Step S101 and the data of the targets included in the particles held by the sound/image integration processing unit 131 and calculates target weights [W_{tID}] of the respective targets using a comparison result.

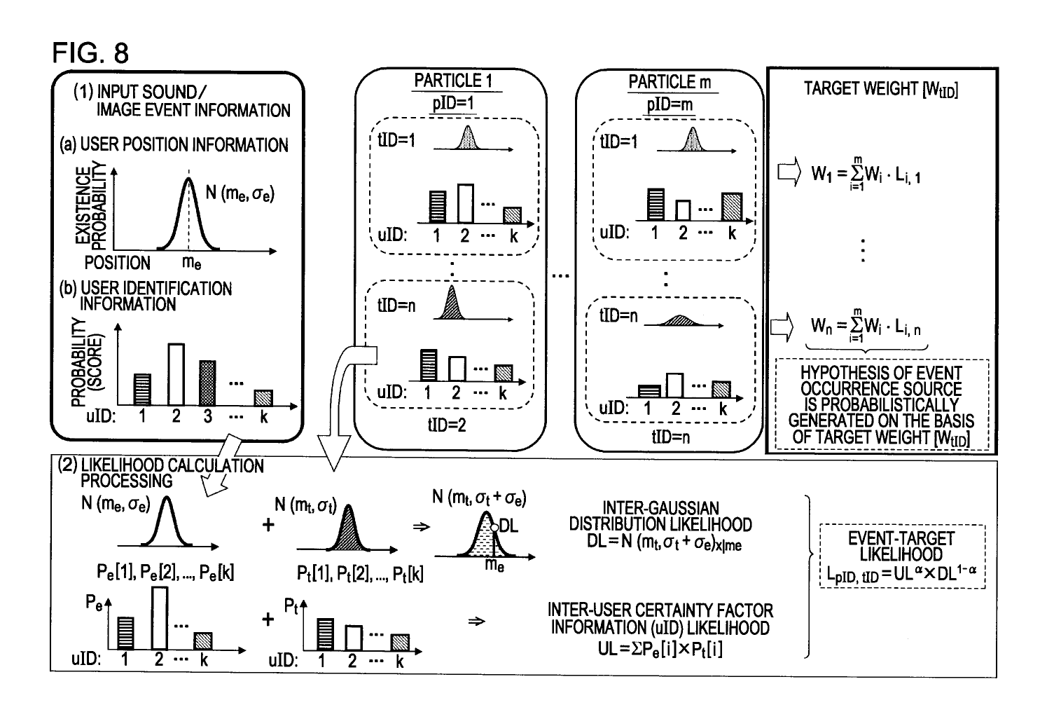

Details of the processing for calculating target weights [W_{tID}] will be described with reference to FIG. 8. The calculation of target weights is executed as processing for calculating n target weights corresponding to the respective targets 1 to n set for the respective particles as shown at a right end in FIG. 8. In calculating the n target weights, first, the sound/image integration processing unit 131 calculates likelihoods as indication values of similarities between input event information shown in (1) in FIG. 8, that is, the event information input to the sound/image integration processing unit 131 from the sound event detection unit 122 or the image event detection unit 112 and respective target data of the respective particles.

An example of likelihood calculation processing shown in (2) in FIG. 8 is an example of calculation of an event-target likelihood by comparison of the input event information (1) and one target data (tID=n) of the particle 1. In FIG. 8, an example of comparison with one target data is shown. However, the same likelihood calculation processing is executed on the respective target data of the respective particles.

The likelihood calculation processing (2) shown at the bottom of FIG. 8 will be described. As shown in (2) in FIG. 8, as the likelihood calculation processing, first, the sound/image integration processing unit 131 individually calculates (a) an inter-Gaussian distribution likelihood [DL] as similarity data between an event concerning user position information and target data and (b) an inter-user certainty factor information (uID) likelihood [UL] as similarity data between an event concerning user identification information (face identification information or speaker identification information) and the target data.

First, processing for calculating (a) the inter-Gaussian distribution likelihood [DL] as similarity data between an event concerning user position information and target data will be described.

A Gaussian distribution corresponding to user position information in the input event information shown in (1) in FIG. 8 is represented as N(mₑ,σₑ). A Gaussian distribution corresponding to user position information of a certain target included in a certain particle of the internal model held by the sound/image integration processing unit 131 is represented as N(mₜ,σₜ). In the example shown in FIG. 8, a Gaussian distribution included in target data of the target n (tID=n) of the particle 1 (pID=1) is represented as N (mₜ, σₜ).

An inter-Gaussian distribution likelihood [DL] as an index for determining a similarity between the Gaussian distributions of the two kinds of data is calculated by the following equation.

DL=N(mₜ,σₜ+σₑ)x|mₑ

This equation is an equation for calculating a value of a position of x=mₑ in a Gaussian distribution with a variance σₜ+σₑ at the center mₜ.

Next, processing for calculating (b) the inter-user certainty factor information (uID) likelihood [UL] as similarity data between an event concerning user identification information (face identification information or speaker identification information) and the target data will be described.

Values (scores) of certainty factors of the respective users 1 to k of the user certainty factor information (uID) in the input event information shown in (1) in FIG. 8 are represented as Pₑ[i]. “i” is a variable corresponding to user identifiers 1 to k.

Values (scores) of certainty factors of the respective users 1 to k of user certainty factor information (uID) of a certain target included in a certain particle of the internal model held by the sound/image integration processing unit 131 are represented as Pₜ[i]. In the example shown in FIG. 8, values (scores) of certainty factors of the respective users 1 to k of the user certainty factor information (uID) included in the target data of the target n (tID=n) of the particle 1 (pID=1) are represented as Pₜ[i].

An inter-user certainty factor information (uID) likelihood [UL] as an index for determining a similarity between the user certainty factor information (uID) of the two kinds of data is calculated by the following equation.

UL=ΣPₑ[i]×Pₜ[i]

This equation is an equation for calculating a sum of products of values (scores) of certainty factors of respective corresponding users included in the user certainty factor information (uID) of the two kinds of data. A value of the sum is the inter-user certainty factor information (uID) likelihood [UL].

Alternatively, a maximum of the respective products, i.e., a value UL=arg max(Pₑ[i]×Pₜ[i]) may be calculated as the inter-user certainty factor information (uID) likelihood [UL] and this value may be used as the inter-user certainty factor information (uID) likelihood [UL].

An event-target likelihood [L_{pID,tID}] as an index of a similarity between the input event information and one target (tID) included in a certain particle (pID) is calculated by using the two likelihoods, that is, the inter-Gaussian distribution likelihood [DL] and the inter-user certainty factor information (uID) likelihood [UL]. In other words, the event-target likelihood [L_{pID,tID}] is calculated by the following equation by using a weight α (α=0 to 1):

[L_{pID,tID}]=UL^{α}×DL^{1-α}

where α is 0 to 1.

In this way, an event-target likelihood [L_{pID,tID}] as an index of a similarity between an event and a target is calculated.

The event-target likelihood [L_{pID,tID}] is calculated for the respective targets of the respective particles. Target weights [W_{tID}] of the respective targets are calculated on the basis of the event-target likelihood [L_{pID,tID}].

The weight [α] applied to the calculation of the event-target target likelihood [L_{pID,tID}] may be a value fixed in advance or may be set to be changed in response to an input event. For example, in the case in which the input event is an image, for example, when face detection is successful and position information can be acquired but face identification has failed, a may be set to 0, and the inter-user certainty factor information (uID) likelihood [UL] may be set to 1. Then, the event-target likelihood [L_{pID,tID}] may be calculated depending only on the inter-Gaussian likelihood [DL], and a target weight [W_{tID}] depending only on the inter-Gaussian likelihood [DL] may be calculated.

Alternatively, for example, in the case in which the input event is sound, for example, when speaker identification is successful and speaker information can be acquired but acquisition of position information has failed, a may be set to 0 and the inter-Gaussian distribution likelihood [DL] may be set to 1. Then, the event-target likelihood [L_{pID,tID}] may be calculated depending only on the inter-user certainty factor information (uID) likelihood [UL], and the target weight [W_{tID}] depending only on the inter-user certainty factor information (uID) likelihood [UL] may be calculated.

An equation for calculating the target weight [W_{tID}] based on the event-target likelihood [L_{pID,tID}] is as follows:

$${W}_{tID} = {\sum }_{pID}^{m} {W}_{pID} {L}_{pID , tID} \qquad [ Expression 1 ]$$

In Expression 1, [W_{pID}] is a particle weight set for the respective particles. Processing for calculating the particle weight [W_{pID}] will be described below. In an initial state, as the particle weight [W_{pID}], a uniform value is set for all the particles (pID=1 to m).

The processing in Step S101 in the flow shown in FIG. 7, that is, the generation of event occurrence source hypotheses corresponding to the respective particles is executed on the basis of the target weight [W_{tID}] calculated on the basis of the event-target likelihood [L_{pID,tID}]. As the target weight [W_{tID}], n data corresponding to the target 1 to n (tID=1 to n) set for the particles are calculated.

Event occurrence source hypothesis targets corresponding to the respective m particles (pID=1 to m) are set to be allocated in response to a ratio of the target weight [W_{tID}].

For example, when n is 4 and the target weight [W_{tID}] calculated corresponding to the targets 1 to 4 (tID=1 to 4) is as follows:
the target 1: target weight=3;
the target 2: target weight=2;
the target 3: target weight=1; and
the target 4: target weight=5, the event occurrence source hypothesis targets of the m particles are set as follows:
30% in the m particles is an event occurrence source hypothesis target 1;
20% in the m particles is an event occurrence source hypothesis target 2;
10% in the m particles is an event occurrence source hypothesis target 3; and
50% in the m particles is an event occurrence source hypothesis target 4.

In other words, event occurrence source hypothesis targets set for the particles are distributed at a ratio in response to weights of the targets.

After setting the hypotheses, the sound/image integration processing unit 131 progresses to Step S103 of the flow shown in FIG. 7. In Step S103, the sound/image integration processing unit 131 calculates weights corresponding to the respective particles, that is, particle weights [W_{pID}]. As the particle weights [W_{pID}], as described above, a uniform value is initially set for the respective particles but is updated in response to an event input.

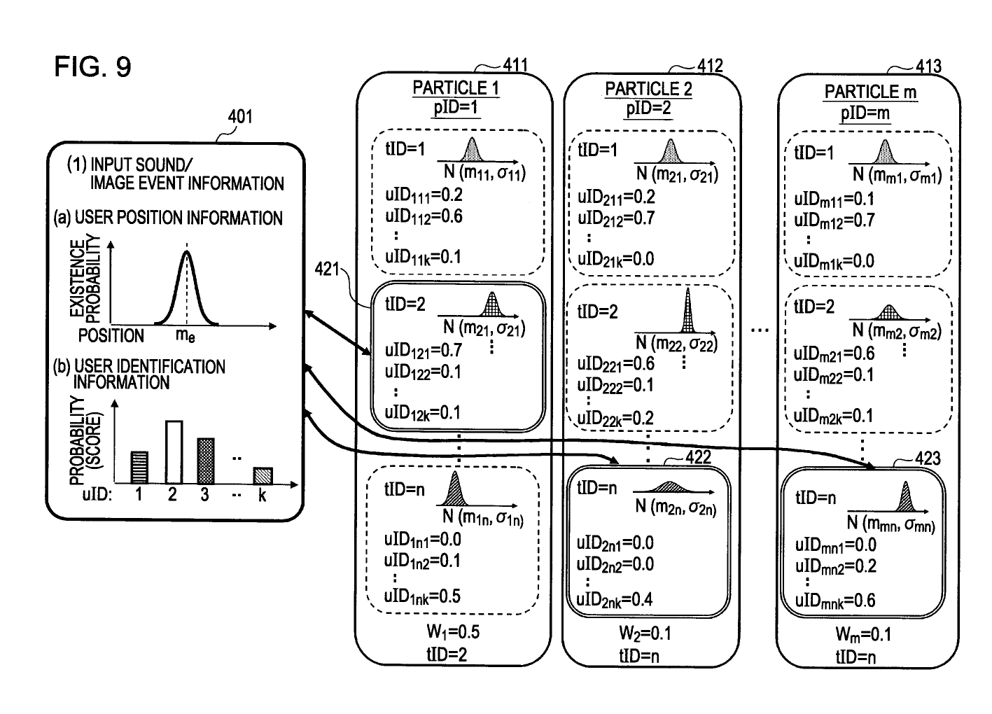

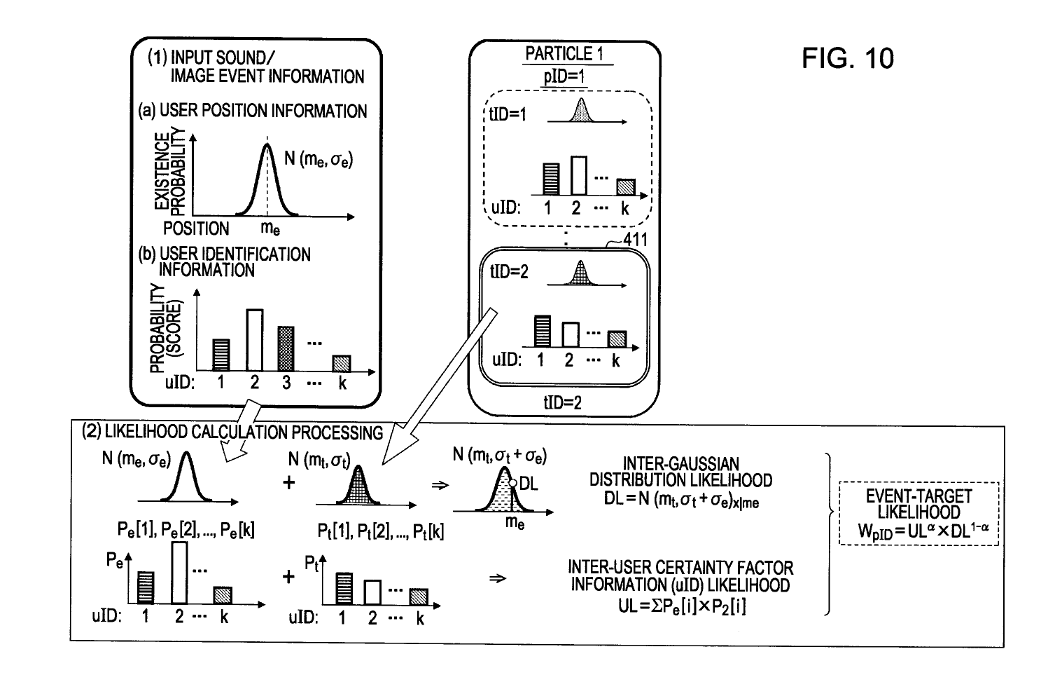

Details of processing for calculating a particle weight [W_{pID}] will be described with reference to FIGS. 9 and 10. The particle weight [W_{pID}] is equivalent to an index for determining correctness of hypotheses of the respective particles for which hypothesis targets of an event occurrence source are generated. The particle weight [W_{pID1}] is calculated as an event-target likelihood that is a similarity between the hypothesis targets of an event occurrence source set for the respective m particles (pID=1 to m) and an input event.

In FIG. 9, event information 401 input to the sound/image integration processing unit 131 from the sound event detection unit 122 or the image event detection unit 112 and particles 411 to 413 held by the sound/image integration processing unit 131 are shown. In the respective particles 411 to 413, the hypothesis targets set in the processing described above, that is, the setting of hypotheses of an event occurrence source in Step S102 of the flow shown in FIG. 7 are set. In the example shown in FIG. 9, as the hypothesis targets, targets are set as follows:
a target 2 (tID=2) 421 for the particle 1 (pID=1) 411;
a target n (tID=n) 422 for the particle 2 (pID=2) 412; and
a target n (tID=n) 423 for the particle m (pID=m) 413.

In the example shown in FIG. 9, the particle weights [W_{pID}] of the respective particles correspond to event-target likelihoods as follows:
the particle 1: an event-target likelihood between the event information 401 and the target 2 (tID=2) 421;
the particle 2: an event-target likelihood between the event information 401 and the target n (tID=n) 422; and
the particle m: an event-target likelihood between the event information 401 and the target n (tID=n) 423.

FIG. 10 shows an example of processing for calculating the particle weight [W_{pID}] for the particle 1 (pID=1). Processing for calculating the particle weight [W_{pID}] shown in (2) of FIG. 10 is likelihood calculation processing the same as that described with reference to (2) of FIG. 8. In this example, the processing is executed as calculation of an event-target likelihood as an index of a similarity between (1) the input event information and an only hypothesis target selected out of the particles.

(2) Likelihood calculation processing shown at the bottom of FIG. 10 is, as described with reference to (2) of FIG. 8, processing for individually calculating (a) an inter-Gaussian distribution likelihood [DL] as similarity data between an event concerning user position information and target data and (b) an inter-user certainty factor information (uID) likelihood [UL] as similarity data between an event concerning user identification information (face identification information or speaker identification information) and the target data.

Processing for calculating (a) the inter-Gaussian distribution likelihood [DL] as similarity data between an event concerning user position information and a hypothesis target is processing described below.

A Gaussian distribution corresponding to user position information in input event information is represented as N(mₑ,σₑ) and a Gaussian distribution corresponding to user position information of a hypothesis target selected out of the particles is represented as N(mₜ,σₜ). The inter-Gaussian distribution likelihood [DL] is calculated by the following equation:

DL=N(mₜ,σₜ+σₑ)x|mₑ

This equation is an equation for calculating a value of a position of x=mₑ in a Gaussian distribution with distribution σₜ+σₑ at the center mₜ.

Processing for calculating (b) the inter-user certainty factor information (uID) likelihood [UL] as similarity data between an event concerning user identification information (face identification information or speaker identification information) and a hypothesis target is processing described below.

Values (scores) of certainty factors of the respective users 1 to k of the user certainty factor information (uID) in the input event information are represented as Pₑ[i]. “i” is a variable corresponding to user identifiers 1 to k.

Values (scores) of certainty factors of the respective users 1 to k of user certainty factor information (uID) of a hypothesis target selected out of the particles are represented as Pₜ[i]. An inter-user certainty factor information (uID) likelihood [UL] is calculated by the following equation:

UL=ΣPₑ[i]×Pₜ[i]

This equation is an equation for calculating a sum of products of values (scores) of certainty factors of respective corresponding users included in the user certainty factor information (uID) of the two kinds of data. A value of the sum is the inter-user certainty factor information (uID) likelihood [UL].

The particle weight [W_{pID}] is calculated by using the two likelihoods, that is, the inter-Gaussian distribution likelihood [DL] and the inter-user certainty factor information (uID) likelihood [UL]. In other words, the particle weight [W_{pID}] is calculated by the following equation by using a weight α (α=0 to 1):

particle weight [W_{pID}]=UL^{α}×DL^{1-α}

where α is 0 to 1.

The particle weight [W_{pID}] is calculated for the respective particles.

As in the processing for calculating the event-target likelihood [L_{pID,tID}] described above, the weight [α] applied to the calculation of the particle weight [W_{pID}] may be a value fixed in advance or may be set to be changed in response to an input event. For example, in the case in which the input event is an image, for example, when face detection is successful and position information can be acquired but face identification has failed, a may be set to 0, and the inter-user certainty factor information (uID) likelihood [UL] may be set to 1. Then, the particle weight [W_{pID}] may be calculated depending only on the inter-Gaussian likelihood [DL]. For example, in the case in which the input event is sound, for example, when speaker identification is successful and speaker information can be acquired but acquisition of position information has failed, α may be set to 0, and the inter-Gaussian distribution likelihood [DL] may be set to 1. Then, the particle weight [W_{pID}] may be calculated depending only on the inter-user certainty factor information (uID) likelihood [UL].

The calculation of the particle weight [W_{pID}] corresponding to the respective particles in Step S103 in the flow shown in FIG. 7 is executed as the processing described with reference to FIGS. 9 and 10 in this way. Subsequently, in Step S104, the sound/image integration processing unit 131 executes processing for resampling particles on the basis of the particle weights [W_{pID}] of the respective particles set in Step S103.

The particle resampling processing is executed as processing for selecting particles out of the m particles in response to the particle weight [W_{pID}]. Specifically, when the number of particles m is 5, particle weights are set as follows:
the particle 1: the particle weight [W_{pID}]=0.40;
the particle 2: the particle weight [W_{pID}]=0.10;
the particle 3: the particle weight [W_{pID}]=0.25;
the particle 4: the particle weight [W_{pID}]=0.05; and
the particle 5: the particle weight [W_{pID}]=0.20. In this case, the particle 1 is resampled at a probability of 40% and the particle 2 is resampled at a probability of 10%. Actually, m is as large as 100 to 1000. A result of the resampling includes particles at a distribution ratio corresponding to weights of the particles.

According to this processing, a large number of particles with large particle weights [W_{pID}] remains. Even after the resampling, the total number [m] of the particles is not changed. After the resampling, the weights [W_{pID}] of the respective particles are reset. The processing is repeated from Step S101 in response to a new event input.

In Step S105, the sound/image integration processing unit 131 executes processing for updating target data (user positions and user certainty factors) included in the respective particles. Respective targets include, as described above with reference to FIG. 6 and the like, the following data:
(a) user positions: a probability distribution of existence positions corresponding to the respective targets [Gaussian distribution: N(mₜ,σₜ)]; and
(b) user certainty factors: values (scores) of probabilities that the respective targets are the respective users 1 to k as the user certainty factor information (uID) indicating who the respective targets are: Pt[i](i=1 to k), i.e., uIDₜ₁=Pt[1], uIDₜ₂=Pt[2], . . . , and uIDₜₖ=Pt[k].

The update of the target data in Step S105 is executed for each of (a) user positions and (b) user certainty factors. First, processing for updating (a) user positions will be described.

The update of the user positions is executed as update processing at two stages, that is, (a1) update processing applied to all the targets of all the particles and (a2) update processing applied to event occurrence source hypothesis targets set for the respective particles.

(a1) The update processing applied to all the targets of all the particles is executed on all of targets selected as event occurrence source hypothesis targets and the other targets. This processing is executed on an assumption that a variance of the user positions expands as time elapses. The user positions are updated by using a Kalman filter according to the time elapsed from the last update processing and position information of an event.

An example of update processing in the case of one-dimensional position information will be described. First, the time elapsed from the last update processing is represented as [dt] and a predicted distribution of the user positions after dt for all the targets is calculated. In other words, an expected value (average) [mₜ] and a variance [σₜ] of a Gaussian distribution N(mₜ,σₜ) as variance information of the user positions are updated as described below:

mₜ=mₜ+xc×dt

σₜ²=σₜ²+σc²×dt

where mₜ is a predicted expected value (predicted state), σₜ² is a predicted covariance (predicted estimate covariance), xc is movement information (control model), and σc² is noise (process noise).

When performed under a condition that users do not move, the update processing can be performed with xc set to 0.

According to this calculation processing, the Gaussian distribution N(mₜ,σₜ) as the user position information included in all the targets is updated.

Concerning the targets as the hypotheses of an event occurrence source each set for the respective particles, update processing is executed by using a Gaussian distribution N(mₑ,σₑ) indicating user positions included in the event information input from the sound event detection unit 122 or the image event detection unit 112.

A Kalman gain is represented as K, an observed value (observed state) included in the input event information N(mₑ,σₑ) is represented as mₑ, and an observed value (observed covariance) included in the input event information N(mₑ,σₑ) is represented as σₑ². Update processing is performed as described below:

K=σₜ²/(σₜ²+σₑ²)

mₜ=mₜ+K(xc−mₜ)

σₜ²=(1−K)σₜ²

Next, (b) the processing for updating user certainty factors executed as processing for updating target data will be described. The target data includes, in addition to the user position information, values (scores) of probabilities that the respective targets are the respective users 1 to k as user certainty factor information (uID) indicating who the respective targets are [Pt[i] (i=1 to k)]. In Step S105, the sound/image integration processing unit 131 also performs processing for updating the user certainty factor information (uID).

The update of the user certainty factor information (uID) of the targets included in the respective particles [Pt[i] (i=1 to k)] is performed by applying an update ratio [β] having a value in a range of 0 to 1 set in advance according to posterior probabilities for all registered users and the user certainty factor information (uID) included in the event information [Pe[i] (i=1 to k)] input from the sound event detection unit 122 or the image event detection unit 112.

The update of the user certainty factor information (uID) of the targets [Pt[i] (i=1 to k)] is executed by the following equation:

Pt [i]=(1−β)×Pt[i]+β*Pe[i]

where, i is 1 to k and B is 0 to 1. The update ratio [β] is a value in a range of 0 to 1 and is set in advance.

In Step S105, the sound/image integration processing unit 131 generates target information on the basis of the following data included in the updated target data and the respective particle weights [W_{pID}] and outputs the target information to the processing decision unit 132:
(a) user positions: a probability distribution of existence positions corresponding to the respective targets [Gaussian distribution: N(mₜ,σₜ)]; and
(b) user certainty factors: values (scores) of probabilities that the respective targets are the respective users 1 to k as the user certainty factor information (uID) indicating who the respective targets are: Pt[i] (i=1 to k), that is, uIDₜ₁=Pt[1], uIDₜ₂=Pt[2], . . . , and uIDₜₖ=Pt[k].

As described with reference to FIG. 5, the target information is generated as weighted sum data of data corresponding to the respective targets (tID=1 to n) included in the respective particles (pID=1 to m). The target information is data shown in the target information 305 at the right end in FIG. 5. The target information is generated as information including (a) user position information and (b) user certainty factor information of the respective targets (tID=1 to n).

For example, user position information in target information corresponding to the target (tID=1) is represented by the following equation:

$${\sum }_{i = 1}^{m} {W}_{i} \cdot N ( {m}_{i 1} , {σ}_{i 1} ) \qquad [ Expression 2 ]$$

In Expression 2, Wᵢ represents the particle weight [W_{pID}]. User certainty factor information in the target information corresponding to the target (tID=1) is represented by the following equation:

$${\sum }_{i = 1}^{m} {W}_{i} \cdot {uID}_{i 11} \\ {\sum }_{i = 1}^{m} {W}_{i} \cdot {uID}_{i 12} \\ ⋮ \\ {\sum }_{i = 1}^{m} {W}_{i} \cdot {uID}_{i 1 k} \qquad [ Expression 3 ]$$

In Expression 3, Wᵢ represents the particle weight [W_{pID}].

The sound/image integration processing unit 131 calculates the target information for the respective n targets (tID=1 to n) and outputs the calculated target information to the processing decision unit 132.

Next, processing in Step S106 shown in FIG. 7 will be described. In Step S106, the sound/image integration processing unit 131 calculates probabilities that the respective n targets (tID=1 to n) are event occurrence sources and outputs the probabilities to the processing decision unit 132 as signal information.

As described above, the [signal information] indicating the event occurrence sources is, concerning a sound event, data indicating who spoke, that is, a [speaker] and, concerning an image event, data indicating whose face corresponds to a face included in an image.

The sound/image integration processing unit 131 calculates probabilities that the respective targets are event occurrence sources on the basis of the number of hypothesis targets of an event occurrence source set in the respective particles. That is, probabilities that the respective targets (tID=1 to n) are event occurrence sources are represented as P(tID=i), where i is 1 to n. In this case, probabilities that the respective targets are event occurrence sources are calculated as P(tID=1): the number of targets allocated with tID=1/m, P(tID=2): the number of targets allocated with tID=2/m, . . . , and P(tID=n): the number of targets allocated with tID=n/m.

The sound/image integration processing unit 131 outputs information generated by this calculation processing, that is, the probabilities that the respective targets are event occurrence sources to the processing decision unit 132 as [signal information].

After the processing in Step S106 ends, the sound/image integration processing unit 131 returns to Step S101 and shifts to a standby state for an input of event information from the sound event detection unit 122 or the image event detection unit 112.

Steps S101 to S106 of the flow shown in FIG. 7 have been described. Even when the sound/image integration processing unit 131 may be unable to acquire the event information shown in FIG. 3B from the sound event detection unit 122 or the image event detection unit 112 in Step S101, update of data of the targets included in the respective particles is executed in Step S121. This update is processing that takes into account a change in user positions according to elapse of time.

This target update processing is processing the same as (al) the update processing applied to all the targets of all the particles in the description of Step S105. This processing is executed on an assumption that a variance of the user positions expands as time elapses. The user positions are updated by using the Kalman filter according to the time elapsed from the last update processing and position information of an event.

An example of update processing in the case of one-dimensional position information will be described. First, the time elapsed from the last update processing is represented as [dt] and a predicted distribution of the user positions after dt for all the targets is calculated. In other words, an expected value (average) [mₜ] and a variance [σₜ] of a Gaussian distribution N(mₜ,σₜ) as variance information of the user positions are updated as described below:

mₜ=mₜ+xc×dt

σₜ²=σₜ²+σc²×dt

where mₜ is a predicted expected value (predicted state), σₜ² is a predicted covariance (predicted estimate covariance), xc is movement information (control model), and σc² is noise (process noise).

When the calculation processing is performed under a condition that users do not move, the update processing can be performed with xc set to 0.

According to the calculation processing, the Gaussian distribution N(mₜ,σₜ) as the user position information included in all the targets is updated.

The user certainty information (uID) included in the targets of the respective particles is not updated unless posterior probabilities or scores [Pe] for all registered users of events can be acquired from event information.

After the processing in Step S121 ends, the sound/image integration processing unit 131 returns to Step S101 and shifts to the standby state for an input of event information from the sound event detection unit 122 or the image event detection unit 112.

The processing executed by the sound/image integration processing unit 131 has been described with reference to FIG. 7. The sound/image integration processing unit 131 repeatedly executes the processing according to the flow shown in FIG. 7 every time event information is input from the sound event detection unit 122 or the image event detection unit 112. By repeating the processing, weights of particles with targets having higher reliabilities set as hypothesis targets increase. By performing resampling processing based on the particle weights, particles having larger weights remain. As a result, data having high reliabilities similar to event information input from the sound event detection unit 122 or the image event detection unit 112 remain. Finally, information having high reliabilities, that is, (a) [target information] as estimation information indicating where a plurality of users are present and who the users are and (b) [signal information] indicating an event occurrence source such as a user who spoke is generated and output to the processing decision unit 132.
(2) User Position and User Identification Processing Using Estimation Information of Existence Probabilities of Targets]
[(2-1) Overview of User Position and User Identification Processing Using Estimation Information of Existence Probabilities of Targets]

The above description [(1) user position and user identification processing by hypothesis update based on event information input] substantially corresponds to the configuration described in Japanese Patent Application No. 2007-193930 which is an earlier application by the same applicant.

The above-described processing is processing for performing user identification processing concerning who users are, processing for estimating a user position, processing for specifying an event occurrence source, and the like through analysis processing of input information from a plurality of channels (also referred to as modalities or modals), specifically, image information acquired by a camera and sound information acquired by a microphone.

However, in the above-described processing, when a new target is generated in the respective particles, for example, an object that is not a character may be erroneously detected as a person and an unnecessary target may be generated due to erroneous detection.

That is, in the above-described processing example, when analysis of an image photographed by the image input unit, such as a camera or the like, for example, existing face detection processing is performed, and a new image region determined to be a face area is detected, a new target is generated. However, the flickering of a curtain or the shadow of various objects may be determined to be a face of a person. If something that is not the face of the person is determined to be the face of the person, generation of new targets is performed, so new targets are set in the respective particles.

Update processing based on new input event information is executed for the new targets that are generated due to erroneous detection. Such processing is wasteful processing, and it is not desirable in that processing for specifying the correspondence relationship between targets and users may be delayed or accuracy may be degraded.

It becomes gradually clear that targets generated due to such erroneous detection are targets based on input event information or targets corresponding to users who are not present during the particle update processing, and targets satisfying a predetermined deletion condition are deleted.

The deletion condition of targets in the above-described processing example is that targets substantially have a uniform position distribution. This deletion condition may cause delay of deletion of erroneously detected targets. This is because the targets substantially having a uniform position distribution are likely to be updated by new input event information. This is also because the targets substantially having a uniform position distribution are not necessarily misaligned significantly with the characteristics of new input event information, have similarity to input event information, so the targets are likely to be updated.

If such target update processing is performed, data of erroneously detected targets, for example, position distribution data is not made uniform, and the targets have target data outside the deletion condition. Accordingly, it takes a lot of time until the predetermined deletion condition is reached. As a result, the targets generated due to erroneous detection remain as a floating ghost, and analysis processing may be delayed or analysis accuracy may be degraded.

The embodiment of the invention described below is an embodiment where problems due to the existence of erroneously detected targets can be excluded. In the configuration of this embodiment described below, information for estimating existence probabilities of targets is set for all targets set in the respective particles.

The estimation information of the target existence probability is set for the targets constituting the respective particles as target existence hypotheses c: {0,1}. Hypothesis information is as follows:
c=1 represents a state where a target exists, and
c=0 represents a state where no target exists.

The number of targets in the respective particles is equal in all particles, and the targets have a target ID (tID) indicating the same object. This basic configuration is the same as the configuration described in [(1) user position and user identification processing by hypothesis update based on event information input].

Meanwhile, in the configuration described below, one target in the respective particles is set as a target generation candidate (tID=cnd). One target generation candidate (tID=cnd) is constantly held in all particles, regardless of presence/absence of event information. That is, even though no user is observed, all particles have one target generation candidate (tID=cnd).

The configuration of the information processing apparatus according to this embodiment has the configuration of FIGS. 1 and 2 the same as the configuration described in [(1) user position and user identification processing by hypothesis update based on event information input]. The sound/image integration processing unit 131 performs processing for determining where a plurality of users are present and who a plurality of users are on the basis of two kinds of input information shown in FIG. 3B from the sound event detection unit 122 and the image event detection unit 112, that is, (a) user position information and (b) user identification information (face identification information or speaker identification information).

The sound/image integration processing unit 131 sets a large number of particles corresponding to the hypotheses concerning where the users are present and who the user are, and performs particle update on the basis of the input information from the sound event detection unit 122 and the image event detection unit 112.

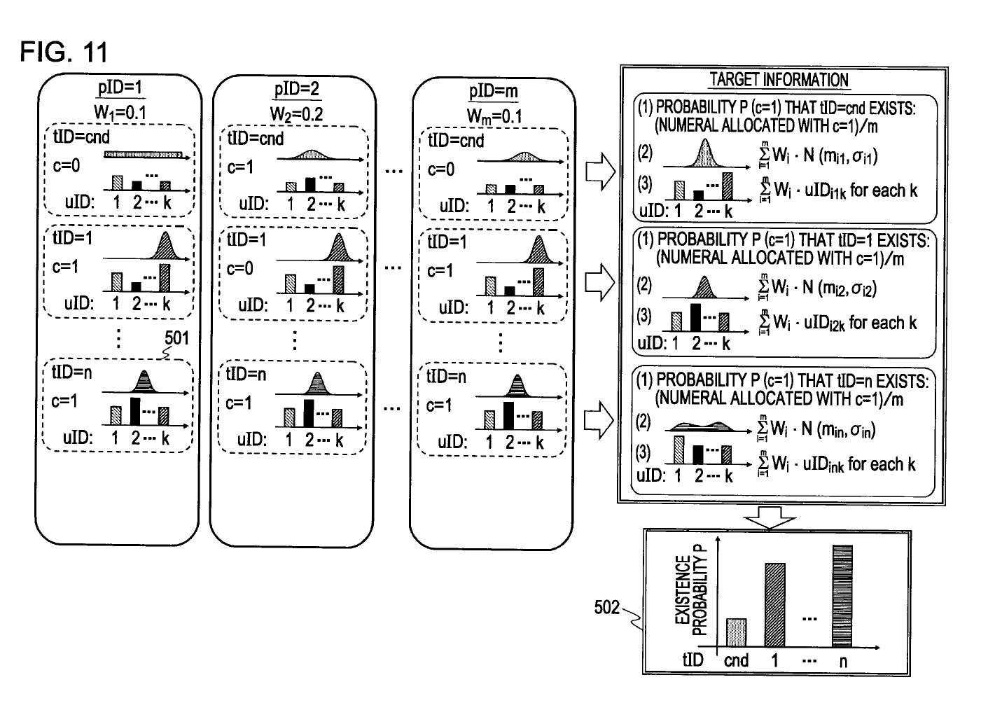

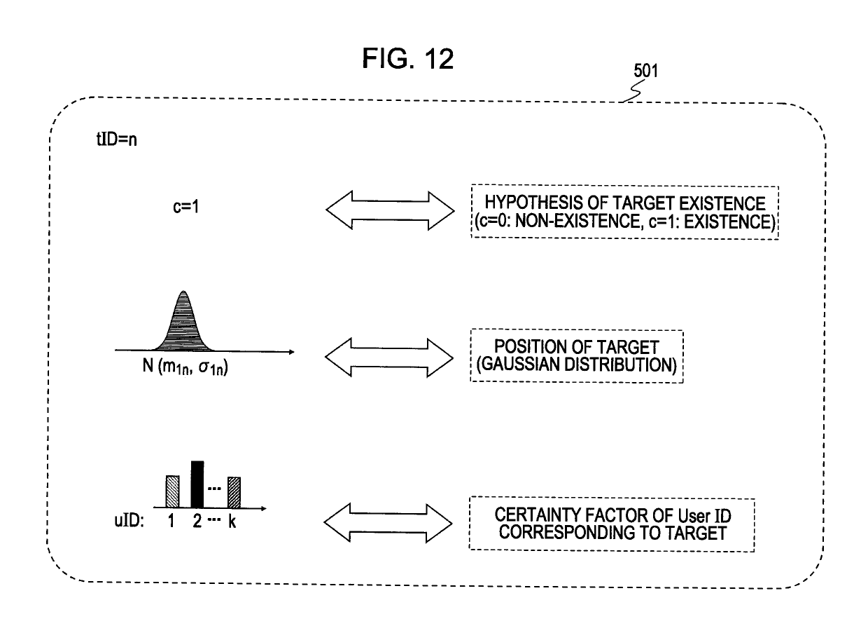

The particles set in this embodiment, the configuration of target data of the targets included in the respective particles, and target information will be described with reference to FIGS. 11 and 12. FIGS. 11 and 12 correspond to FIGS. 5 and 6 described in [(1) user position and user identification processing by hypothesis update based on event information input].

The sound/image integration processing unit 131 has a plurality of particles set in advance. In FIG. 11, m particles 1 to m are shown. Particle IDs (pID=1 to m) as identifiers are set in the respective particles.

A plurality of targets corresponding to virtual objects corresponding to objects for position and identification are set in the respective particles.

In this example, one target in the respective particles is set as a target generation candidate (tID=cnd). One target generation candidate (tID=cnd) is constantly held in all particles, regardless of presence/absence of event information. That is, even though no user is observed, all particles have one target generation candidate (tID=cnd).

In the example shown in FIG. 11, a target at the top in the respective particles (pID=1 to m) is a target generation candidate (tID=cnd). The target generation candidate (tID=cnd) has the same target data as other targets (tID=1 to n). In this embodiment, as shown in FIG. 11, one particle includes n+1 targets (tID=cnd, 1 to n) including the target generation candidate (tID=cnd). The configuration of target data of the respective targets included in the respective particles is shown in FIG. 12.

FIG. 12 is a diagram showing the configuration of target data of one target (target ID: tID=n) 501 included in the particle 1 (pID=1) shown in FIG. 11. As shown in FIG. 12, target data of the target 501 has (1) target existence hypothesis information [c{0,1}] for estimating existence probabilities of targets, (2) a probability distribution [Gaussian distribution: N(m₁ₙ,σ₁ₙ)] of existence positions of the targets, and (3) user certainty factor information (uID) indicating who the targets are.

The respective kinds of data (2) and (3) are the same as described with reference to FIG. 6 in [(1) user position and user identification processing by hypothesis update based on event information input]. In this processing example, in addition to the respective kinds of data (2) and (3), target data has (1) target existence hypothesis information [c{0,1}] for estimating existence probabilities of targets.

In this processing example, target existence hypothesis information is set for the respective targets.

The sound/image integration processing unit 131 receives event information shown in FIG. 3B from the sound event detection unit 122 and the image event detection unit 112, that is, (a) user position information and (b) user identification information (face identification information or speaker identification information), and performs update processing of the m particles (pID=1 to m). This update processing updates target data, that is, (1) target existence hypothesis information [c{0,1}] for estimating existence probabilities of targets, (2) a probability distribution [Gaussian distribution: N(m₁ₙ,σ₁ₙ)] of existence positions of the targets, and (3) user certainty factor information (uID) indicating who the targets are.

The sound/image integration processing unit 131 executes the update processing so as to generate (a) [target information] as estimation information indicating where a plurality of users are present and who the users are, (b) [signal information] indicating an event occurrence source such as a user who spoke, and outputs the information to the processing decision unit 132.

As shown in the target information at the right end in FIG. 11, the [target information] is generated as weighted sum data of target data corresponding to the respective targets (tID=cnd, 1 to n) included in the respective particles (pID=1 to m).

In this processing example, the [target information] includes information indicating (1) existence probabilities of targets, (2) existence positions of the targets, and (3) who the targets are (which one of uID1 to uIDk the targets are). The respective kinds of information (2) and (3) are the same as information described in [(1) user position and user identification processing by hypothesis update based on event information input] and the same as information included in the target information 305 shown in FIG. 5.

(1) The existence probabilities of the targets are target information newly added in this processing example.

The existence probabilities [PtID(c=1)] of the targets are calculated by the following equation.

PtID(c=1)={number of targets having tID allocated with c=1}/{number of particles}

Similarly, the probability PtID(c=0) that no target exists is calculated by the following equation. PtID(c=0)={number of targets having tID allocated with c=0}/{number of particles}

In this equation, the {number of targets having tID allocated with c=1} is the number of targets allocated with c=1 from among targets having the same target identifier (tID) set in the respective particles. The {number of targets having tID allocated with c=0} is the number of targets allocated with c=0 from among targets having the same target identifier (tID).

The sound/image integration processing unit 131 generates target information including, for example, existence probability data 502 the same as shown in the lower right portion of FIG. 11, that is, an existence probability P for each target ID (tID=cnd, 1 to n), and outputs the target information to the processing decision unit 132.

The sound/image integration processing unit 131 outputs (1) existence probabilities of targets, (2) existence positions of the targets, and (3)who the targets are (which one of uID1 to uIDk the targets are) to the processing decision unit 132 as target information.

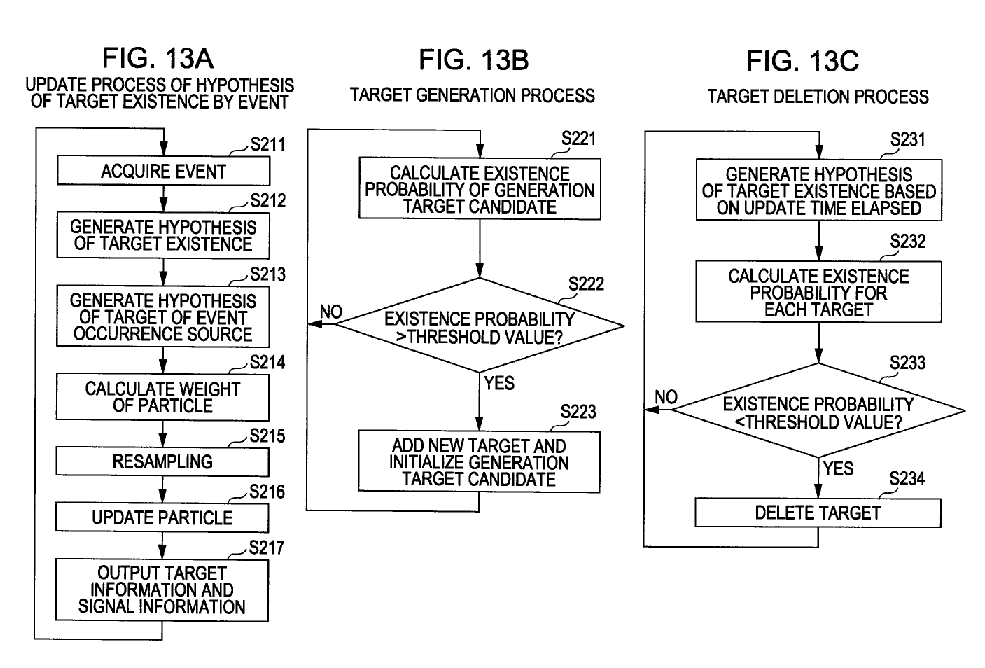

FIGS. 13A to 13C are flowcharts illustrating a processing sequence executed by the sound/image integration processing unit 131.

In this embodiment, the sound/image integration processing unit 131 separately executes three processes shown in FIG. 13A to 13C, that is, (a) hypothesis update process of target existence by event, (b) target generation process, and (c) target deletion process.

Specifically, the sound/image integration processing unit 131 executes (a) the hypothesis update process of target existence by event as event driven processing which is executed in response to event occurrence.

(b) The target generation process is executed periodically for every predetermined period set in advance or is executed immediately after (a) the hypothesis update process of target existence by event.

(c) the target deletion process is executed periodically for every predetermined period set in advance.

Hereinafter, the flowcharts shown in FIGS. 13A to 13C will be described.

### [(2-2) Hypothesis Update Process of Target Existence by Event]

First, the hypothesis update process of target existence by event shown in FIG. 13A will be described. This processing corresponds to processing in Steps S101 to S106 in the flow of FIG. 7 described in [(1) user position and user identification processing by hypothesis update based on event information input].

It is assumed that the sound/image integration processing unit 131 sets a plurality (m) of particles shown in FIG. 11 before the hypothesis update process of target existence by event shown in FIG. 13A. Particle IDs (pID=1 to m) as identifiers are set for the respective particles. The respective particles include n+1 targets including a target generation candidate (tID=cnd).

In Step S211, the sound/image integration processing unit 131 receives event information shown in FIG. 3B from the sound event detection unit 122 and the image event detection unit 112, that is, user position information and user identification information (face identification information or speaker identification information).

As event information is input, in Step S212, hypotheses of target existence are generated.

The hypothesis c:{0,1} of existence of each target in the respective particles is generated by using any one of (a) a method that the hypothesis c:{0,1} of existence of each target is generated randomly without depending on a previous state, and (b) a method that the hypothesis c:{0,1} is generated depending on the previous state and according to a transition probability (c=0→1, c=1'40).

According to the method (a), for the respective targets included in the respective particles, the hypothesis c:{0,1} of target existence is set randomly to one of 0 (nonexistence) or 1 (existence).

According to the method (b), the hypothesis c:{0,1} of existence of each target is changed in response to the previous state by using a transition probability (a probability of c=0→1, a probability of c=1→0). This processing may refer to other kinds of data of the targets, that is, a probability distribution [Gaussian distribution: N(m₁ₙ,σ₁ₙ)] of existence positions of the targets, and user certainty factor information (uID) indicating who the targets are. When these kinds of data are data that affirm target existence, [c=1] indicating target existence may be set, and when these kinds of data are data that negate target existence, [c=0] indicating nonexistence may be set.

Next, in Step S213, processing for setting a hypothesis of an event occurrence source target is performed. This processing corresponds to processing in Step S102 in the flow of FIG. 7 described above.

In Step S213, the sound/image integration processing unit 131 sets a hypothesis of an event occurrence source for the respective m particles (pID=1 to m) shown in FIG. 11. The event occurrence source is, for example, in the case of a sound event, a user who spoke and, in the case of an image event, a user who has an extracted face.

In this embodiment, a hypothesis that an acquired event occurs from a target is set randomly in the respective particles by the number of events, and hypothesis setting is made under the following restrictions:
(restriction 1) a target in which a hypothesis of target existence is c=0 (non-existence) is not set as an event occurrence source,
(restriction 2) the same target is set as an event occurrence source for different events, and
(restriction 3) when the condition “(number of events)>(number of targets)” is established at the same time, events more than the number of targets are determined to be noise.

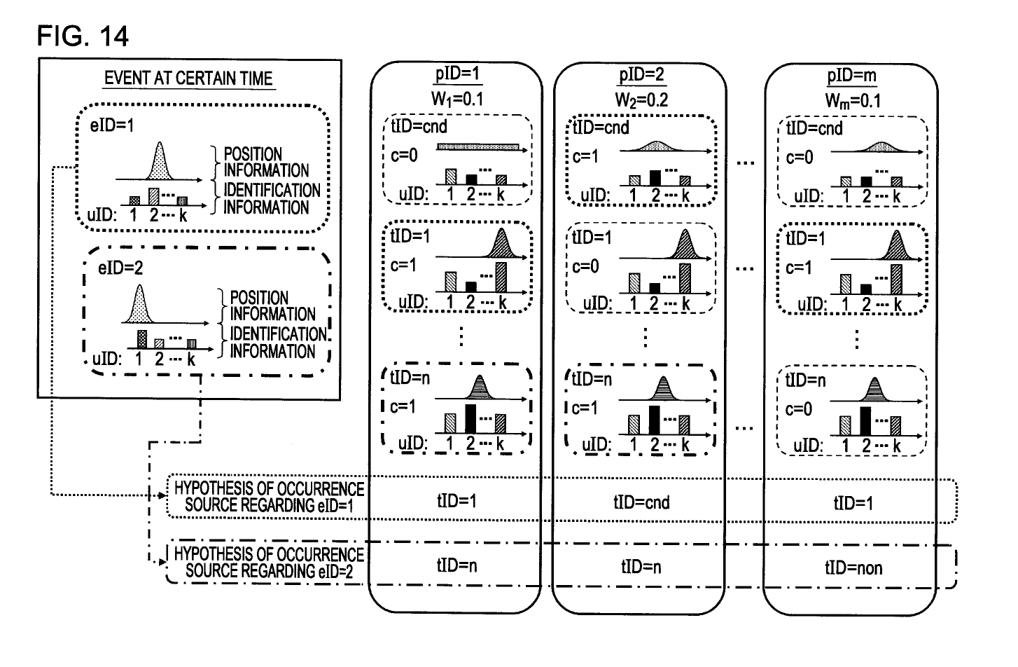

Under these restrictions, for example, as shown in FIG. 14, for one event (eID=1), the particle 1 (pID=1) is set as tID=1, the particle 2 (pID=2) is set as tID=cnd, . . . , and the particle m (pID=m) is set as tID=1. In this way, a hypothesis that an event occurrence source is any one of the targets (tID=cnd, 1 to n) is set for the respective particles.

When a device for performing event detection, for example, a device for performing event detection based on face recognition has low reliability or the like, adjustment may be made at the time of hypothesis setting so as to prevent the target generation candidate (tID=cnd) from being frequency updated due to event information based on erroneous detection. Specifically, processing is performed for making it difficult for the target generation candidate (tID=cnd) to become a hypothesis of an event occurrence source target.

That is, when a hypothesis that an acquired event occurs from a target is set in the respective particles, in addition to the above-described restrictions, randomness of hypothesis setting is biased so as to make it difficult for the target generation candidate (tID=cnd) to become the hypothesis of the event occurrence source target. Specifically, for example, processing for selecting one event occurrence source target corresponding to a particle from among tID=cnd and 1 to n and setting an event occurrence source hypothesis is performed as follows.

First, at the time of hypothesis setting corresponding to the particles, (first tID selection) tID is selected randomly from tID=cnd and 1 to n. When any one of tID=1 to n is selected, the selected tID is set as a hypothesis. When tID=cnd is selected, second tID selection is performed. (second tID selection) tID is selected randomly from tID=cnd and 1 to n. When any one of tID=1 to n is selected, the selected tID is set as a hypothesis. Only when tID=cnd is selected twice successively, an event occurrence source target corresponding to the particle is set as tID=cnd.

In this processing example, only when tID=cnd is selected twice successively, the event occurrence source hypothesis corresponding to the particle is set as tID=cnd. For example, with such biased processing, a probability that tID=cnd becomes the event occurrence source hypothesis corresponding to the particle as compared with tID=1 to n can be reduced.

It is not necessary to associate the hypotheses tID=cnd and 1 to n of the event occurrence sources with the respective particles for all events. For example, a predetermined ratio (for example, 10%) in a detected event may be analyzed to be noise, no hypothesis of an event occurrence source target may be set for such an event analyzed to be noise. A ratio that hypothesis setting is not performed may be decided depending on detection performance of an event detection device (for example, a face identification processing execution unit) to be used.

A configuration example of particles set by processing in Steps S212 and S213 is shown in FIG. 14. In the example shown in FIG. 14, hypothesis data (tID=xx) of event occurrence sources for two events (eID=1, eID=2) at a certain time is shown at the bottom of the respective particles. The two events (eID=1, eID=2) correspond to two face areas detected from an image photographed by a camera at a certain time.

In the example shown in FIG. 14, hypothesis data of the event occurrence sources for the first event (eID=1) is set as follows: the particle 1 (pID=1) is set as tID=1, the particle 2 (pID=2) is set as tID=cnd, . . . , and the particle m (pID=m) is set as tID=1.

Hypothesis data of the event occurrence source for the second event (eID=2) is set as follows: the particle 1 (pID=1) is set as tID=n, the particle 2 (pID=2) is set as tID=n, . . . , and the particle m (pID=m) is set as tID=non (no hypothesis setting).

Hypothesis setting of the event occurrence source target is performed under the above-described restrictions, that is, (restriction 1) a target in which a hypothesis of target existence is c=0 (non-existence) is not set as an event occurrence source, (restriction 2) the same target is set as an event occurrence source for different events, and (restriction 3) when the condition “(number of events)>(number of targets)” is established at the same time, events more than the number of targets are determined to be noise.

In the example shown in FIG. 14, tID=non (no hypothesis setting) is set for the particle m (pID=m) as the hypothesis of the event occurrence source target for the second event (eID=2). This setting is processing based on (restriction 1) and (restriction 3). That is, one target (tID=1) is present in the particle m (pID=m), and the hypothesis of target existence is set as c=1 (existence). For other targets, c=0 (non-existence) is set.

A target (tID=1) where it is assumed that one of the two events (eID=1, eID=2) occurred at the same time exists (c=1) may be set as the hypothesis of the event occurrence source target, but for at least one of the two events, the hypothesis of the event occurrence source target may not be set. This is processing under the above-described restrictions.

As described above, when the condition “number of events>number of targets” is satisfied, there is an event (eID) allocated with no event occurrence source target (tID) in the respective particles. In such a case, tID=non is set. That is, processing is performed on the probability that an event is noise. P(tID=non) represents a probability that “an event is noise”.

Next, the processing progresses to Step S214 in the flow shown in FIG. 13A, and weights [W_{pID}] of the particles are calculated. This processing corresponds to Step S103 in the flow of FIG. 7 described in [(1) user position and user identification processing by hypothesis update based on event information input]. That is, the weights [W_{pID}] of the respective particles are calculated on the basis of the hypotheses of the event occurrence source target.

This processing is the same as processing in Step S103 in the flow of FIG. 7, and is processing described with reference to FIGS. 9 and 10. That is, the particle weight [W_{pID}] is calculated as an event-target likelihood that is a similarity between an input event and target data of the event occurrence source hypothesis targets corresponding to the respective particles. As the particle weights [W_{pID}], as described above, a uniform value is initially set for the respective particles but is updated in response to an event input.

As described with reference to FIGS. 9 and 10, the particle weight [W_{pID}] is equivalent to an index for determining correctness of hypotheses of the respective particles for which hypothesis targets of an event occurrence source are generated. The particle weight [W_{pID}] is calculated as an event-target likelihood that is a similarity between hypothesis targets of an event occurrence source set in the respective m particles (pID=1 to m) and an input event.

In a hypothesis target setting example shown in FIG. 14, the following event-target likelihoods are calculated. Calculation of particle weight [W_{pID}] based on event (eID=1) input

particle 1,
an event-target likelihood between event information (see the event information 401 of FIGS. 9 and 10) of the event (eID=1) and the target 1 (tID=1)
   particle 2
an event-target likelihood between event information of the event (eID=1) and the target cnd (tID=cnd)
   particle 3
an event-target likelihood between the event information of event (eID=1) and the target (tID=1)

In this way, the likelihoods are calculated and the values calculated based on the likelihoods are set as the respective particle weights.

Calculation of particle weight [W_{pID}] based on event (eID=2) input
particle 1
an event-target likelihood between event information of the event (eID=2) and the target n (tID=n)
   particle 2
an event-target likelihood between event information of the event (eID=2) and the target n (tID=n)
   particle 3
an event-target likelihood between event information of the event (eID=2) and the target non (tID=non)

In this way, the likelihoods are calculated and the values calculated based on the likelihoods are set as the respective particle weights.

Specifically, as described with reference to FIG. 10, the particle weight [W_{pID}] is calculated by using the two likelihoods, that is, an inter-Gaussian distribution likelihood [DL] and an inter-user certainty factor information (uID) likelihood [UL]. In other words, the particle weight [W_{pID}] is calculated by the following equation by using a weight α (α=0 to 1):

particle weight [W_{pID}]=UL^{α}×DL^{1-α}

where α is 0 to 1.

The particle weight [W_{pID}] is calculated for the respective particles.

With regard to the weight of the target generation candidate (tID=cnd), the particle weight [W_{pID}] calculated by the likelihood calculation processing is multiplied by a generation probability Pb of the target generation candidate (tID=cnd) so as to obtain a final particle weight [W_{pID}]. That is, the weight of the target generation candidate (tID=cnd) is represented by the following equation.

W_{pID}=Pb×(UL^{α}×DL^{1-α})

The generation probability Pb of the target generation candidate (tID=cnd) is a probability that, in the hypothesis setting of the event occurrence source for the respective particles, the target generation candidate (tID=cnd) from tID=cnd and 1 to n is set as an event occurrence source. That is, for a particle with a target generation candidate as a target hypothesis, the event-target likelihood is multiplied by a coefficient smaller than 1 so as to calculate a particle weight.

Thus, the weight of a particle with the target generation candidate (tID=cnd) as a hypothesis of an event occurrence source decreases. This processing reduces an influence on target information of an uncertain target (tID=cnd).

When a target forming a hypothesis is noise, that is, when a target non (tID=non) is set, there is no target data for likelihood calculation. In this case, temporary target data having a uniform distribution of position or identification information is set as target data for calculation of a similarity to event information, and a likelihood between temporarily set target data and input event information is calculated so as to calculate a particle weight.

As described above, the particle weights are calculated for the respective particles every time event information is input. The final particle weight is decided by performing the following regularization processing as final adjustment on the calculated values.
(1) regularization by substitution with a previous weight
(2) regularization by multiplication to the previous weight

The regularization processing is processing for setting the sum of the weights of the particles 1 to m to [1].

In (1) regularization by substitution with the previous weight, the particle weights are calculated and normalized by likelihood information calculated on the basis of new event information input without taking the previous weight into consideration, so the particle weights are decided. When R is a regularization term, for a particle where a hypothesis target of an event occurrence source is not a target generation candidate (tID=cnd), the particle weight [W_{pID}] is calculated by the following equation.

W_{pID}=R×(UL^{α}×DL^{1-α})

Further, for a particle where a hypothesis target of an event occurrence source is a target generation candidate (tID=cnd), the particle weight [W_{pID}] is calculated by the following equation.

W_{pID}=R×Pb×(UL^{α}DL^{1-α})

In this way, the particle weights [W_{pID}] of the respective particles are calculated.

In (2) regularization by multiplication to the previous weight, when there are the particle weights [W_{pID(t-1)}] set on the basis of past (time: t-1) event information, the set particle weights [W_{pID(t-}1)] are multiplied by likelihood information calculated on the basis of new event information input so as to calculate particle weights [W_{pID(t)}]. Specifically, for a particle where a hypothesis target of an event occurrence source is not a target generation candidate (tID=cnd), the particle weight [W_{pID(t)}] is calculated by the following equation.

W_{pID(t)}=R×(UL^{α}DL^{1-α})×W_{pID(t-1)}

Further, for a particle where a hypothesis target of an event occurrence source is a target generation candidate (tID=cnd), the particle weight [W_{pID(t)}] is calculated by the following equation.

W_{pID(t)}=R×Pb×(UL^{α}DL^{1-α})×W_{pID(t-1)}

In this way, the particle weights [W_{pID(t)}] of the respective particles are calculated.

In Step S214 in the flow shown in FIG. 13, the sound/image integration processing unit 131 decides the particle weights of the respective particles by the above-described processing. Next, the processing progresses to Step S215, and the sound/image integration processing unit 131 executes resampling processing of the particles based on the particle weights [W_{pID}] of the respective particles set in Step S214. This processing corresponds to processing in Step S104 in the flow of FIG. 7 described in [(1) user position and user identification processing by hypothesis update based on event information input]. The particles are resampled on the basis of the weights of the particles by sampling with replacement.

The resampling processing of the particles is executed as processing for selecting particles from among the m particles in response to the particle weights [W_{pID}]. Specifically, when the number of particles is m=5, particle weights are set as follows:
the particle 1: particle weight [W_{pID}]=0.40,
the particle 2: particle weight [W_{pID}]=0.10,
the particle 3: particle weight [W_{pID}]=0.25,
the particle 4: particle weight [W_{pID}]=0.05, and
the particle 5: particle weight [W_{pID}]=0.20. In this case, the particle 1 is resampled at a probability of 40% and the particle 2 is resampled at a probability of 10%. Actually, m is as large as 100 to 1000. A result of the resampling includes particles at a distribution ratio corresponding to weights of the particles.

According to this processing, a large number of particles with large particle weights [W_{pID}] remain. Even after the resampling, the total number [m] of the particles is not changed. After the resampling, the weights [W_{pID}] of the respective particles are reset. The processing is repeated from Step S211 in response to a new event input.

Next, in Step S216, the sound/image integration processing unit 131 executes update processing of particles. For the respective resampled particles, target data of an event occurrence source is updated by using an observed value (event information).

As described above with reference to FIG. 12, the respective targets have target data, that is, (1) target existence hypothesis information [c{0,1}] for estimating existence probabilities of targets, (2) a probability distribution [Gaussian distribution: N(mₜ,σₜ)] of existence positions of the targets, and (3) user certainty factor information (uID) indicating who the targets are.

In Step S215, the update of target data is executed for the respective kinds of data (2) and (3) from among data (1) to (3). (1) The target existence hypothesis information [c{0,1}] is newly set in Step S212 when an event is acquired, so update is not executed in Step S216.

(2) Update processing of the probability distribution [Gaussian distribution: N(mₜ,σₜ)] of existence positions of the targets is executed as processing the same as in [(1) user position and user identification processing by hypothesis update based on event information input]. That is, this processing is executed as update processing at two stages, that is, (p) update processing applied to all the targets of all the particles and (q) update processing applied to event occurrence source hypothesis targets set for the respective particles.

(p) The update processing applied to all the targets of all the particles is executed on all of targets selected as event occurrence source hypothesis targets and the other targets. This processing is executed on an assumption that a variance of the user positions expands as time elapses. The user positions are updated by using a Kalman filter according to the time elapsed from the last update processing and position information of an event.

An example of update processing in the case of one-dimensional position information will be described. First, the time elapsed from the last update processing is represented as [dt] and a predicted distribution of the user positions after dt for all the targets is calculated. In other words, an expected value (average) [mₜ] and a variance [σₜ] of a Gaussian distribution N(mₜ,σₜ) as variance information of the user positions are updated as described below:

mₜ=mₜ+xc×dt

σₜ²=σₜ²+σc²×dt

where mₜ is a predicted expected value (predicted state), σₜ² is a predicted covariance (predicted estimate covariance), xc is movement information (control model), and σc² is noise (process noise).

When performed under a condition that users do not move, the update processing can be performed with xc set to 0.

According to this calculation processing, the Gaussian distribution N(mₜ,σₜ) as the user position information included in all the targets is updated.

Concerning (q) the targets as the hypotheses of an event occurrence source each set for the respective particles, update processing is executed by using a Gaussian distribution N(mₑ,σₑ) indicating user positions included in the event information input from the sound event detection unit 122 or the image event detection unit 112.

A Kalman gain is represented as K, an observed value (observed state) included in the input event information N(mₑ,σₑ) is represented as mₑ, and an observed value (observed covariance) included in the input event information N(mₑ,σₑ) is represented as σₑ². Update processing is performed as described below:

K=σₜ²/(σₜ²,σₑ²

mₜ=mₜ+K(xc−mₜ)

σₜ²=(1−K)σhd t²

Next, (3) processing for updating user certainty factors executed as processing for updating target data will be described. The processing for updating user certainty factors may be executed as processing the same as in [(1) user position and user identification processing by hypothesis update based on event information input], but an exclusive user estimation method described below may be applied. The exclusive user estimation method corresponds to the configuration described in Japanese Patent Application No. 2008-177609 which was previously filed by the applicant.

<Processing to which Exclusive User Estimation Method is Applied>

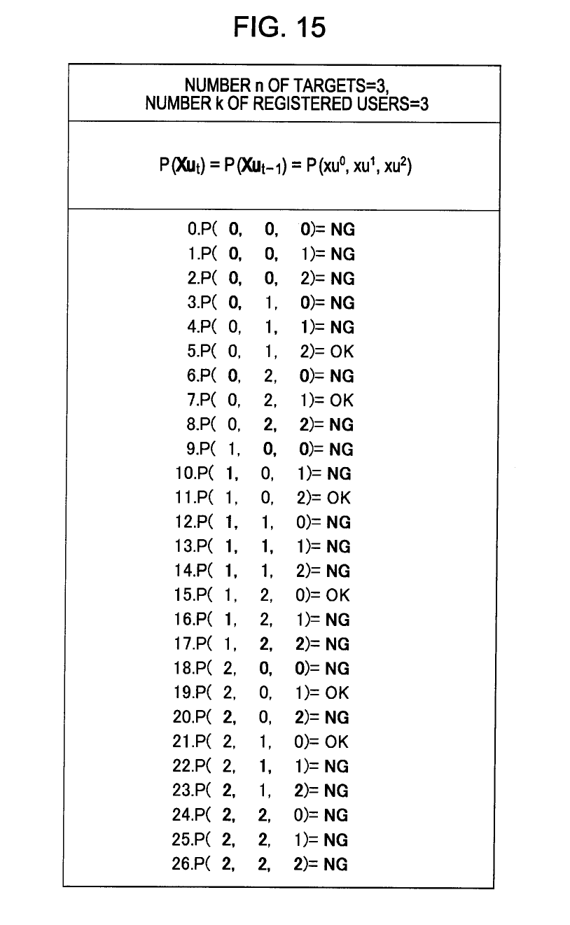

An overview of an exclusive user estimation method described in Japanese Patent Application No. 2008-177609 will be described with reference to FIGS. 15 to 18.

In the processing described in [(1) user position and user identification processing by hypothesis update based on event information input], at the time of the update of targets set in the respective particles, update is executed while maintaining independence between targets. That is, update of one kind of target data has no relation with update kind of another target data, and respective kinds of target data are updated independently. If such processing is performed, update is executed without excluding an event which does not actually occur.

Specifically, target update may be made on the basis of estimation that different targets are the same user, and processing may not be performed for excluding an event that the same person plurally exists during estimation processing.

The exclusive user estimation method described in Japanese Patent Application No. 2008-177609 is processing for performing high-accuracy analysis by excluding independence between targets. That is, uncertain and asynchronous position information and identification information from a plurality of channels (modalities or modals) are probabilistically integrated, and to estimate where a plurality of targets are present and who the targets are, a joint probability of user IDs (UserID) concerning all the targets is treated while independence between targets is excluded, thereby improving estimation performance of user identification.

Target position and user estimation processing executed as processing for generating target information {Position,User ID (UserID)} described in [(1) user position and user identification processing by hypothesis update based on event information input] is formulated, so a system for estimating a probability [p] in the following equation (Equation 1) is constructed.

P(Xₜ,θₜ|zₜ,Xₜ₋₁) (Equation 1)

P(a|b) represents a probability that a state a occurs when an input b is obtained.

In Equation 1, the parameters are as follows:

t: time

Xₜ={xₜ¹,xₜ², . . . , xₜ^{θ}, . . . ,xₜⁿ}: target information for n persons at time t

x={xₚ,xᵤ}: target information {Position,User ID (UserID)}

zₜ={zpₜ,zuₜ): an observed value {Position,User ID (UserID)} at time t

θₜ: a state where an observed value zₜ at time t is an occurrence source of target information x^{θ} of a target [θ] (θ=1 to n)

zₜ={zpₜ,zuₜ) represents an observed value {Position,User ID (UserID)} at time t and corresponds to event information in [(1) user position and user identification processing by hypothesis update based on event information input]. That is, zpₜ corresponds to user position information (position) included in event information, for example, user position information having a Gaussian distribution shown in (a) of FIG. 8 (1). zuₜ corresponds to user identification information (UserID) included in event information, for example, user identification information represented by the values (scores) of certainty factors of the respective users 1 to k shown in (b) of FIG. 8 (1).

With regard to Equation 1 representing the probability P, that is, P=(Xₜ,θₜ|zₜ,Xₜ₋₁), when two inputs on the right side, that is, (input 1) an observed value [zₜ] at time t, and (input 2) target information [Xₜ₋₁] at previous observation time t-1 are obtained, Equation 1 represents values of probabilities that the following two states on the left side occur: (state 1) a state [σₜ] where the observed value [zₜ] at time t is an occurrence source of target information [x^{θ}] (θ=1 to n); and (state 2) a state [Xₜ]={xpₜ,xuₜ} where target information occurs at time t.

The target position and user estimation processing executed as processing for generating target information {Position,User ID (UserID)} described in [(1) user position and user identification processing by hypothesis update based on event information input] is referred to as a system for estimating the probability [P] in the above-described equation (Equation 1).

If the probability calculation equation (Equation 1) is factorized by θ, the equation can be transformed as follows.

P(Xₜ,θₜ|zₜ, Xₜ₋₁)=P(Xₜ|θₜ, zₜ, Xₜ₋₁)×P(θₜ|zₜ, Xₜ₋₁)

A front-side equation and a rear-side equation included in a result of factorization are respectively referred to as Equation 2 and 3 as follows.

P(Xₜ|θₜ,zₜ,Xₜ₋₁) (Equation 2)

P(θₜ|zₜ,Xₜ₋₁) (Equation 3)

That is, the following relationship is established. (Equation 1)=(Equation 2)×(Equation 3)

With regard to Equation 3, that is, P(θₜ|zₜ,Xₜ₋₁), when inputs, that is, (input 1) an observed value [zₜ] at time t and (input 2) target information [X_{t-1]} at previous observation time [t-1] are obtained, a probability that (state 1) a state [θₜ] where an occurrence source of the observed value [zₜ] is [x^{θ}] is calculated by Equation 3.

In [(1) user position and user identification processing by hypothesis update based on event information input], the probability [θₜ] is estimated by processing using a particle filter.

Specifically, estimation processing using, for example, a [Rao-Blackwellised Particle Filter] is performed.

With regard to Equation 2, that is, P(Xₜ|θₜ,zₜ,Xₜ₋₁), when inputs, that is, (input 1) an observed value [zₜ] at time t, (input 2) target information [Xₜ₋₁] at previous observation time [t-1], and (input 3) a probability [θₜ] that the observed value [zₜ] is [x^{θ}] are obtained, Equation 2 represents a probability that (state) a state where target information [Xₜ] is obtained at time t occurs.

With regard to Equation 2, that is, P(Xₜ|θₜ,zₜ,Xₜ₋₁), in order to estimate the probability that the state of Equation 2 occurs, target information [Xₜ] represented as a value of a state to be estimated is first developed to two state values, that is, target information [Xpₜ] corresponding to position information and target information [Xuₜ] corresponding to user identification information.

With this development processing, the above-described equation (Equation 2) is expressed as follows.

P(Xₜ|θₜ, zₜ, Xₜ₋₁)=P(Xpₜ, Xuₜ|θₜ, zpₜ, zₜ, Xpₜ₋₁, Xuₜ₋₁)

In this equation, zpₜ is target position information included in the observed value [zₜ] at time t, and zuₜ is user identification information included in the observed value [zₜ] at time t.

Assuming that target information [Xpₜ] corresponding to target position information and target information [Xuₜ] corresponding to user identification information are independent, the developed equation of Equation 2 can be expressed by a multiplication equation of two equations as follows.

$$P ( {X}_{t} \vert {θ}_{t} , {z}_{t} , {X}_{t - 1} ) = P ( {Xp}_{t} , {Xu}_{t} \vert {θ}_{t} , {zp}_{t} , {zu}_{t} , {Xp}_{t - 1} , {Xu}_{t - 1} ) \\ = P ( {Xp}_{t} \vert {θ}_{t} , {zp}_{t} , {Xp}_{t - 1} ) \times P ( {Xu}_{t} \vert {θ}_{t} , {zu}_{t} , {Xu}_{t - 1} )$$

A front-side equation and a rear-side equation included in the multiplication equation are respectively referred to as Equations 4 and 5 as follows.

P(Xpₜ|θₜ,zpₜ,Xpₜ₋₁) (Equation 4)

P(Xuₜ|θₜ,zuₜ,Xuₜ₋₁) (Equation 5)

That is, the following relationship is established. (Equation 2)=(Equation 4)×(Equation 5)

With regard to Equation 4, that is, P(Xpₜ|θₜ,zpₜ,Xpₜ₋₁), target information that is updated by an observed value [zpₜ] corresponding to position information included in Equation 4 is only target information [xpₜ^{θ}] concerning a position of a specific target (θ).

If target information [xpₜ^{θ}]: xpₜ¹, xpₜ², . . . , and xpₜⁿ concerning positions corresponding to the respective targets θ=1 to n is independently set, Equation 4, that is, P(Xpₜ|θₜ,zpₜ,Xpₜ₋₁) can be developed as follows.

$$\begin{matrix}P ( {Xp}_{t} \vert {θ}_{t} , {zp}_{t} , {Xp}_{t - 1} ) = P ( \begin{matrix}{xp}_{t}^{1} , {xp}_{t}^{2} , … {xp}_{t}^{n} \vert {θ}_{t} , \\ {zp}_{t} , {xp}_{t - 1}^{1} , {xp}_{t - 1}^{2} , … , {xp}_{t - 1}^{n}\end{matrix} ) \\ = P ( {xp}_{t}^{1} \vert {xp}_{t - 1}^{1} ) P ( {xp}_{t}^{2} \vert {xp}_{t - 1}^{2} ) … \\ P ( {xp}_{t}^{θ} \vert {zp}_{t} , {xp}_{t - 1}^{θ} ) … P ( {xp}_{t}^{n} \vert {xp}_{t - 1}^{n} )\end{matrix}$$

In this way, Equation 4 can be developed as a multiplication equation of the probability values of the respective targets (θ=1 to n), and target information [xpₜ^{θ}] concerning a position of a specific target (θ) is updated by the observed value [zpₜ].

In the processing described in [(1) user position and user identification processing by hypothesis update based on event information input], a Kalman filter is applied so as to estimate a value corresponding to Equation 4.

Meanwhile, in the processing described in [(1) user position and user identification processing by hypothesis update based on event information input], update of user positions included in target data set in the respective particles is executed as update processing at two stages, that is, (a1) update processing applied to all the targets of all the particles, and (a2) update processing applied to event occurrence source hypothesis targets set for the respective particles.

(a1) The update processing applied to all the targets of all the particles is executed on all of targets selected as event occurrence source hypothesis targets and the other targets. This processing is executed on an assumption that a variance of the user positions expands as time elapses. The user positions are updated by using a Kalman filter according to the time elapsed from the last update processing and position information of an event.

That is, the probability calculation processing expressed by P(xpₜ|xpₜ₋₁) is applied and estimation processing by a Kalman filter using only a movement model (time attenuation) is applied to the probability calculation processing.

As (a2) the update processing applied to event occurrence source hypothesis targets set for the respective particles, update processing using user position information: zpₜ (Gaussian distribution: N(mₑ,σₑ)) included in event information input from the sound event detection unit 122 or the image event detection unit 112 is executed.

That is, the probability calculation processing expressed by P(xpₜ|zpₜ,xpₜ₋₁) is applied and estimation processing by a Kalman filter using a movement model and an observation model is applied to the probability calculation processing.

Next, an equation corresponding to user identification information (UserID) obtained by developing Equation 2, that is, Equation 5 is analyzed.

P(Xuₜ|θₜ,zuₜ,Xuₜ₋₁) (Equation 5)

In Equation 5, target information that is updated by an observed value [zuₜ] corresponding to user identification information (UserID) is only target information [xuₜ^{θ}] concerning user identification information of a specific target (θ).

If target information [xuₜ^{θ}]: xuₜ¹, xuₜ², . . . , and xuₜⁿ concerning user identification information corresponding to the respective targets θ=1 to n is independently set, Equation 5, that is, P(Xuₜ|θₜ,zuₜ,Xuₜ₋₁) can be developed as follows.

$$\begin{matrix}P ( {Xu}_{t} \vert {θ}_{t} , {zu}_{t} , {Xu}_{t - 1} ) = P ( \begin{matrix}{xu}_{t}^{1} , {xu}_{t}^{2} , … , {xu}_{t}^{n} \vert {θ}_{t} , \\ {zu}_{t} , {xu}_{t - 1}^{1} , {xu}_{t - 1}^{2} , … , {xu}_{t - 1}^{n}\end{matrix} ) \\ = P ( {xu}_{t}^{1} \vert {xu}_{t - 1}^{1} ) P ( {xu}_{t}^{2} \vert {xu}_{t - 1}^{2} ) … \\ P ( {xu}_{t}^{θ} \vert {zu}_{t} , {xu}_{t - 1}^{θ} ) … P ( {xu}_{t}^{n} \vert {xu}_{t - 1}^{n} )\end{matrix}$$

In this way, Equation 5 can be developed as a multiplication equation of probability values of the respective targets (θ=1 to n), and only target information [xuₜ^{θ}] concerning user identification information of a specific target (θ) is updated by the observed value [zuₜ].

Update processing of targets based on user identification information in the processing described in [(1) User position and user identification processing by hypothesis update based on event information input] is performed as follows.

Probability values (scores): Pt[i] (i=1 to k) that are the respective users 1 to k as user certainty factor information (uID) indicating who the targets are included in the respective targets set in the respective particles.

With regard to the update of targets by user identification information included in event information, there is no change insofar as no observed value is provided. This is expressed by the following equation.

P(xuₜ|xuₜ₋₁)

This probability is not changed insofar as no observed value is provided.

The update of the user certainty factor information (uID) of the targets included in the respective particles [Pt[i] (i=1 to k)] is performed by applying an update ratio [β] having a value in a range of 0 to 1 set in advance according to posterior probabilities for all registered users and the user certainty factor information (uID) included in the event information [Pe[i] (i=1 to k)] input from the sound event detection unit 122 or the image event detection unit 112.

The update of the user certainty factor information (uID) of the targets [Pt[i] (i=1 to k)] is executed by the following equation:

Pt[i]=(1−β)×Pt[i]+β*Pe[i]

where, i is 1 to k and B is 0 to 1. The update ratio [β] is a value in a range of 0 to 1 and is set in advance.

This processing can be expressed by the following probability calculation equation.

P(xuₜ|zuₜ,xuₜ₋₁)

The update processing based on user identification information described in [(1) User position and user identification processing by hypothesis update based on event information input] is executed as processing for estimating the probability P of Equation 5 corresponding to user identification information (UserID) obtained by developing Equation 2.

P(Xuₜ|θₜ,zuₜ,Xuₜ₋₁) (Equation 5)

However, in [(1) User position and user identification processing by hypothesis update based on event information input], processing is performed while independence of user identification information (UserID) between targets is maintained.

Therefore, for example, even though there are a plurality of different targets, it may be determined that the same user identifier (uID: UserID) is the most likely identifier, and update based on this determination may be executed. That is, update may be made by estimation processing that a plurality of different targets set in the respective particles correspond to the same user, which does not actually occur.

Processing is performed assuming independence of a user identifier (uID: UserID) between targets, so target information that is updated by an observed value [zuₜ] corresponding to user identification information is only target information [xuₜ^{θ}] of a specific target (θ). Accordingly, to update user identification information (uID: UserID) in all the targets, the observed values [zuₜ] for all the targets should be provided.

As described above, in [(1) user position and user identification processing by hypothesis update based on event information input], analysis processing is performed with independence between targets. Accordingly, estimation processing may be executed without excluding an event that does not actually occur, target update may be wasteful, and efficiency and accuracy of estimation processing in user identification may be degraded.

To solve such problems, independence between targets is excluded, a plurality of target data are associated with each other, and processing for updating a plurality of target data is executed on the basis of one kind of observation data. By performing such processing, update can be performed while an event that does not actually occur is excluded, and efficient analysis can be realized with high accuracy.

In the information processing apparatus of this embodiment, the sound/image integration processing unit 131 in the configuration shown in FIG. 2 executes processing for updating target data including user certainty factor information indicating which of the users corresponds to a target as an event occurrence source on the basis of user identification information included in event information. During this processing, processing is executed for updating a joint probability of candidate data of users associated with targets on the basis of user identification information included in event information and calculating user certainty factors corresponding to the targets using the value of the updated joint probability.

A joint probability of user identification information (UserID) concerning all the targets is treated while independence between targets is excluded, so estimation performance of user identification can be improved.

The sound/image integration processing unit 131 performs processing by Equation 5 with independence of target information [Xuₜ] corresponding to user identification information excluded.

P(Xuₜ|θₜ,zuₜ,Xuₜ₋₁) (Equation 5)

In Equation 5, target information that is updated by an observed value [zuₜ] corresponding to user identification information (UserID) is only target information [xuₜ^{θ}] concerning user identification information of a specific target (θ).

Equation 5 can be developed as follows.

P(Xuₜ|θₜ,zuₜ, Xuₜ₋₁)=P(xuₜ¹, xuₜ², . . . , xuₜⁿ|Γₜ,zuₜ, xuₜ₋₁¹, xuₜ₋₁², . . . , xuₜ₋₁ⁿ)

Target update processing is performed without assuming independence between targets of target information [Xuₜ] corresponding to user identification information. That is, processing is performed taking into consideration a joint probability that a plurality of events occur. For this processing, Bayes' theorem is used.

According to Bayes' theorem, when a probability (anterior probability) that an event x occurs is P(x) and a probability (posterior probability) that the event x occurs after an event z occurs is P(x|z), the following equation is established.

P(x|z)=(P(z|x)P(x))/P(z)

The equation (Equation 5) corresponding to user identification information (UserID) described above is developed by using Bayes' theorem P(x|z)=(P(z|x)P(x))/P(z).

P(Xuₜ|θₜ,zuₜ,Xuₜ₋₁) (Equation 5)

A result of development is as follows.

P(Xuₜ|θₜ,zuₜ,Xuₜ₋₁)=P(θₜ,zuₜ,Xuₜ₋₁|Xuₜ)P(Xuₜ)/P(θₜ,zuₜ,Xuₜ₋₁) (Equation 6)

In Equation 6, θₜ represents a state when an observed value zₜ at time t is an occurrence source of target information x^{θ} of a target [θ] (θ=1 to n), and zuₜ represents user identification information included in the observed value [zₜ] at time t. If it is assumed that “θₜ and zuₜ” depends only on target information [Xuₜ] at time t corresponding to user identification information (does not depend on Xuₜ₋₁), Equation 6 can be further developed as follows.

$$\begin{matrix}P ( {Xu}_{t} \vert {θ}_{t} , {zu}_{t} , {Xu}_{t - 1} ) = P ( \begin{matrix}{θ}_{t} , {zu}_{t} , \\ {Xu}_{t - 1} \vert {Xu}_{t}\end{matrix} ) P ( {Xu}_{t} ) / \\ P ( {θ}_{t} , {zu}_{t} , {Xu}_{t - 1} ) \\ P ( {θ}_{t} , {zu}_{t} \vert {Xu}_{t} ) \\ = P ( {Xu}_{t - 1} \vert {Xu}_{t} ) P ( {Xu}_{t} ) / \\ P ( {θ}_{t} , {zu}_{t} ) P ( {Xu}_{t - 1} )\end{matrix} \qquad ( Equation 7 )$$

By calculating Equation 7, estimation of user identification, that is, user identification processing is performed.

With regard to a user certainty factor (uID) for any target i, that is, a probability of xu (UserID), a probability that the target is the user identifier (UserID) in the joint probability is marginalized. For example, the probability of xu (UserID) is calculated by the following equation.

P(xuⁱ)=Σₓᵤ₌ₓᵤᵢP(Xu)

If Equation 5 corresponding to user identification information (UserID) is developed by using Bayes' theorem, Equation 7 is obtained.

P(Xuₜ|θₜ,zuₜ,Xuₜ₋₁) (Equation 5)

P(Xuₜ|θₜ,zuₜ,Xuₜ₋₁)=P(θₜ,zuₜ|Xuₜ)P(Xuₜ₋₁|Xuₜ)P(Xuₜ)/P(θₜ,zuₜ)P(Xuₜ₋₁ (Equation 7)

In Equation 7, it is assumed that only P(θₜ,zuₜ) is uniform.

Then, Equation 5 and Equation 7 can be expressed as follows.

$$\begin{matrix}P ( {Xu}_{t} \vert {θ}_{t} , {zu}_{t} , {Xu}_{t - 1} ) & ( Equation 5 ) \\ = P ( {θ}_{t} , {zu}_{t} \vert {Xu}_{t} ) P ( {Xu}_{t - 1} \vert {Xu}_{t} ) P ( {Xu}_{t} ) / P ( {θ}_{t} , {zu}_{t} ) P ( {Xu}_{t - 1} ) \approx P ( {θ}_{t} , {zu}_{t} \vert {Xu}_{t} ) P ( {Xu}_{t - 1} \vert {Xu}_{t} ) P ( {Xu}_{t} ) / P ( {Xu}_{t - 1} ) & ( Equation 7 )\end{matrix}$$

“≈” is a proportional representation.

Therefore, Equation 5 and Equation 7 can be expressed by Equation 8.

P(Xuₜ|θₜ,zuₜ,Xuₜ₋₁) (Equation 5)

=R×P(θₜ,zuₜ|Xuₜ)P(Xuₜ₋₁|Xuₜ)P(Xuₜ)/P(Xuₜ₋₁) (Equation 8)

In Equation 8, R is a regularization term.

In Equation 8, a restriction that the same identifier (UserID) is not allocated to a plurality of targets” is expressed by using anterior probabilities P(Xuₜ) and P(Xuₜ₋₁). A probability is set as follows: (restriction 1): when any repeated xu (user identifier (UserID)) exists in P(Xu)=P(xu¹,xu², . . . ,xuⁿ), P(Xuₜ)=P(Xuₜ₋₁)=NG(P=0.0) ; otherwise, P(Xuₜ)=P(Xuₜ₋₁)=OK(0.0<P≦1.0).

FIG. 15 shows an initial state setting example under the above-described restriction when the number of targets is n=3 (0 to 2), and the number of registered users is k=3 (0 to 2).

As shown in FIG. 15, candidates of user IDs (uID=0 to 2) corresponding to three targets IDs (tID=0,1,2) include 27 kinds of candidate data as follows.

tID0,1,2=(0,0,0) to (2,2,2)

For the 27 kinds of candidate data, a joint probability is represented as user certainty factors of all the user IDs (0 to 2) associated with the target IDs (2, 1, 0).

In the example shown in FIG. 15, when any repeated xu (user identifier (UserID)) exists in P(Xu)=P(xu¹, xu², . . . , xuⁿ), a joint probability: P=0(NG) is set, and for a candidate described as P=OK other than P=0(NG), a probability value (0.0<P≦1.0) larger than 0 is set to the joint probability: P.

As described above, the sound/image integration processing unit 131 performs initial setting of a joint probability of candidate data of users associated with targets under the restriction that the same user identifier (UserID) is not allocated to a plurality of targets.

Initial setting of probability values is performed such that a probability value of a joint probability P(Xu) of candidate data when the same user identifier (UserID) is set to different targets is P(Xu)=0.0, and a probability value of other target data is P(Xu)=0.0<P≦1.0.

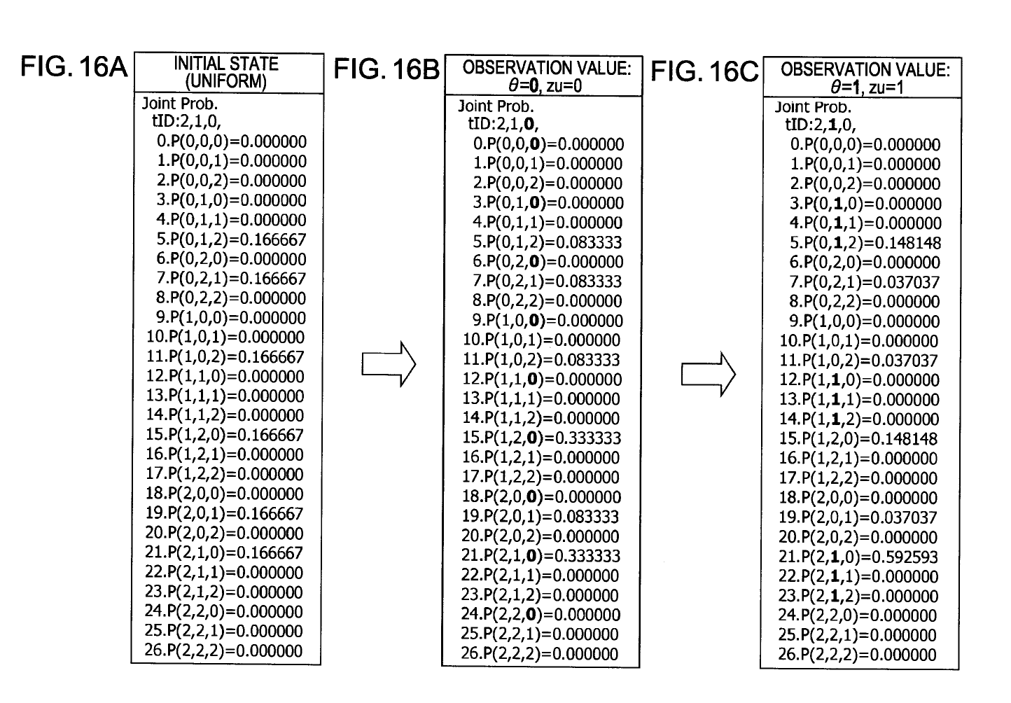

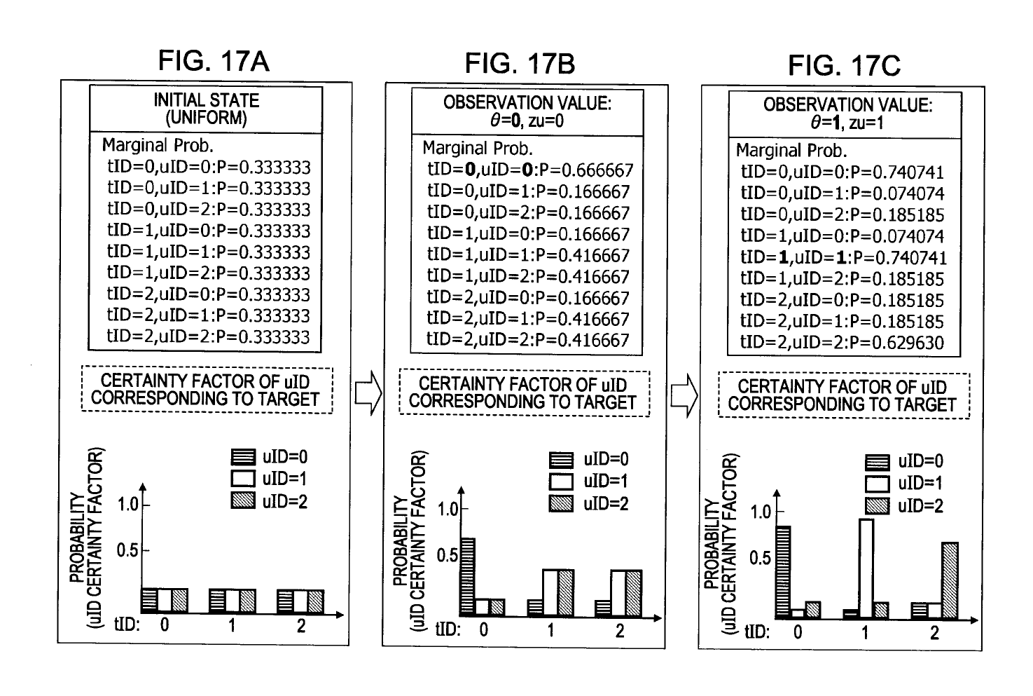

FIGS. 16A to 16C and 17A to 17C are diagrams illustrating an analysis processing example according to this embodiment with independence between targets excluded under the restriction that “the same identifier (UserID) is not allocated to a plurality of targets”.

The processing example of FIGS. 16A to 16C and 17A to 17C are processing examples with independence between targets excluded. Processing is performed by using Equation 8 generated on the basis of Equation 5 corresponding to user identification information (UserID) described above under the restriction that the same user identifier (UserID) as user identification information is not allocated to a plurality of different targets.

P(Xuₜ|θₜ,zuₜ,Xuₜ₋₁) (Equation 5)

=R×P(θₜ,zuₜ|Xuₜ)P(Xuₜ₋₁|Xuₜ)P(Xuₜ)/P(Xuₜ₋₁) (Equation 8)

That is, with regard to Equation 8, processing is performed such that, when any repeated xu (user identifier (UserID)) exists in P(Xu)=P(xu¹,xu², . . . ,xuⁿ), the probability is set as P(Xuₜ)=P(Xuₜ₋₁)=NG (P=0.0); otherwise, the probability is set as P(Xuₜ)=P(Xuₜ₋₁)=OK(0.0<P≦1.0).

Equation 8 is expressed as follows:

$$\begin{matrix}P ( {Xu}_{t} \vert {θ}_{t} , {zu}_{t} , {Xu}_{t - 1} ) & ( Equation 5 ) \\ = R \times P ( {θ}_{t} , {zu}_{t} \vert {Xu}_{t} ) P ( {Xu}_{t - 1} \vert {Xu}_{t} ) P ( {Xu}_{t} ) / P ( {Xu}_{t - 1} ) \\ = R \times [ \begin{matrix}anterior \\ probability P\end{matrix} ] \times [ \begin{matrix}state transition \\ proba bili ty P\end{matrix} ] \times ( \begin{matrix}P ( {Xu}_{t} ) / \\ P ( {Xu}_{t - 1} )\end{matrix} ) & ( Equation 8 )\end{matrix}$$

where [anterior probability P] is P(θₜ,zuₜ|Xuₜ) and [state transition probability P] is P(Xuₜ|Xuₜ).

The processing examples of FIGS. 16A to 16C and 17A to 17C are different processing examples where, when any repeated xu (user identifier (UserID)) exists in P(Xu)=P(xu¹,xu², . . . ,xuⁿ), P=0 (NG) is set.

The [anterior probability P] included in Equation 8 is expressed as follows:

P(θₜ,zuₜ|Xuₜ)=P(θₜ,zuₜ|xuₜ¹,xuₜ², . . . ,xuₜ^{θ}, . . . ,xuₜⁿ)

In this equation, when xuₜ^{θ}=zuₜ, an anterior probability P of an observed value is set as P=A=0.8; otherwise, the anterior probability is set as P=B=0.2.

With regard to the [state transition probability P] P(Xuₜ|Xuₜ) included in Equation 8, when there is no change in the user identifier (UserID) for all the targets at time t and t-1, the state transition probability is set as P=C=1.0; otherwise, the state transition probability is set as P=D=0.0.

FIGS. 16A to 16C and 17A to 17C are diagrams showing a transition example of probability values of the user IDs (0 to 2) corresponding to the target IDs (2, 1, 0), that is, user certain factors (uID) when observation information “θ=0,zu=0” and “θ=1,zu=1” is sequentially observed at two kinds of observation time under such condition settings. A user certainty factor is calculated as a joint probability of data of all the user IDs (0 to 2) associated with all the target IDs (2, 1, 0).

“θ=0,zu=0” indicates that observation information [zu] corresponding to a user identifier (uID=0) is observed from a target (θ=0).

“θ=1,zu=1” indicates that observation information [zu] corresponding to a user identifier (uID=1) is observed from a target (θ=1).

As shown in an initial state column of FIG. 16A, candidates of user IDs (uID=0 to 2) corresponding to three target IDs (tID=0, 1, 2) include 27 kinds of candidate data as follows.

tID0,1,2=(0,0,0) to (2,2,2)

For the 27 kinds of candidate data, a joint probability is calculated as user certainty factors of all the user IDs (0 to 2) associated with all the target IDs (2, 1, 0). Unlike the initial state of FIG. 13A, when any repeated xu (user identifier (UserID)) exists, a probability (user certainty factor) is set as P=0. For other candidates, an equivalent probability is set. In the example shown in the drawing, a probability value is set as P=0.166667.

FIG. 16B shows changes in user certainty factors (user certainty factors of all the user IDs (0 to 2) associated with all the target IDs (2, 1, 0)) calculated as a joint probability when observation information “θ=0,zu=0” is observed.

The observation information “θ=0,zu=0” indicates that observation information from the target ID=0 is the user ID=0.

A probability P of candidate data set with tID=0 and the user ID=0 from among the 27 candidates, excluding candidates set with P=0(NG) in the initial state, is increased on the basis of this observation information, and other probabilities P are decreased.

In the initial state, a probability of a candidate set with tID=0 and the user ID=0 from among candidates set with a probability P=0.166667 is increased and set as P=0.333333, and other probabilities P are decreased and set as P=0.0083333.

FIG. 16C shows changes in user certainty factors (user certainty factors of all the user IDs (0 to 2) associated with all the target IDs (2, 1, 0)) calculated as a joint probability when the observation information “θ=1,zu=1” is observed.

The observation information “θ=1,zu=1” indicates that observation information from the target ID=1 is the user ID=1.

A probability P (joint probability) of candidate set with tID=1 and the user ID=1 from among the 27 candidates, excluding candidates set with P=0 (NG) in the initial state, is increased, and other probabilities P are decreased.

As a result, as shown in FIG. 16C, the probability values are classified into four kinds of probability values.

Candidates having a highest probability are candidates that are set with tID=0 and the user ID=0 and set with tID=1 and the user ID=1, not set as P=0 (NG) in the initial state. A joint probability of these candidates becomes P=0.592593.

Candidates having a second highest probability are candidates that are set with either tID=0 and the user ID=0 or tID=1 and the user ID=1, not set as P=0 (NG) in the initial state. A probability of these candidates becomes P=0.148148.

Candidates having a third highest probability are candidates that are not set as P=0 (NG) in the initial state and are set with neither tID=0 and ID=0 nor tID=1 and the user ID=1. A probability of these candidates becomes P=0.037037.

Candidates having a lowest probability are candidates that are set as P=0(NG) in the initial state. A probability of these candidates becomes P=0.0.

FIGS. 17A to 17C show a result of marginalization obtained by the processing shown in FIGS. 16A to 16C.

FIGS. 17A to 17C correspond to FIGS. 16A to 16C.

That is, update is sequentially performed from an initial state of FIG. 17A and results shown in FIGS. 17B and 17C are obtained. Data shown in FIGS. 17A to 17C, that is, a probability P that tID=0 is uID=0, a probability P that tID=0 is uID=1, . . . , a probability P that tID=2 is uID=1, and a probability P that tID=2 is uID=3, are calculated from the result shown in FIGS. 16A to 16C. The probabilities of FIGS. 17A to 17C are calculated by adding, that is, marginalizing the probability value of relevant data from the 27 kinds of candidate data of FIGS. 16A to 16C. For example, the probabilities are calculated by the following equation.

P(xuⁱ)=Σₓᵤ₌ₓᵤᵢP(Xu)

As shown in FIG. 17A, in an initial state, the probability P that tID=0 is uID=0, the probability P that tID=0 is uID=1, . . . , the probability P that tID=2 is uID=1, and the probability P that tID=2 is uID=3 are uniform as P=0.333333.

A graph at the lower part of FIG. 17A graphically shows the probabilities.

FIG. 17B shows a result of update when the observation information “θ=0,zu=0” is observed, and shows the probability P that tID=0 is uID=0, . . . , and the probability P that tID=2 is uID=3.

Only the probability that tID=0 is uID=0 is set high, and accordingly, two probabilities of the probability P that tID=0 is uID=1 and the probability P that tID=0 is uID=2 are decreased.

In this processing example, for tID=1, the probability that tID=1 is uID=0 decreases, the probability that tID=1 is uID=1 increases, and the probability that tID=1 is uID=2 increases, and for tID=2, the probability that tID=2 is uID=0 decreases, the probability that tID=2 is uID=1 increases, and the probability that tID=2 is uID=2 increases. In this way, probabilities (user certainty factors) of the targets (tID=1, 2) different from the target (tID=0) from which the observation information “θ=0,zu=0” is supposedly acquired are also changed.

Processing shown in FIGS. 16A to 16C and 17A to 17C is a processing example with independence of respective targets excluded. That is, any observation data has an influence on data corresponding to one target and data of other targets.

Referring to Equation 8, processing shown in FIGS. 16A to 16C and 17A to 17C is a processing example where, under restriction 1, that is, when any repeated xu (user identifier (UserID)) exists in P(Xu)=P(xu¹, xu², . . . , xuⁿ) , a probability is set as P(Xuₜ)=P(Xuₜ₋₁)=NG (P=0.0); otherwise, a probability is set as P(Xuₜ)=P(Xuₜ₋₁)=OK(0.0<P≦1.0).

P(Xuₜ|θₜ,zuₜ,Xuₜ₋₁) (Equation 5)

=R×P(θₜ,zuₜ|Xuₜ)P(Xuₜ|Xuₜ)P(Xuₜ)/P(Xuₜ₋₁) (Equation 8)

As a result of this processing, as shown in FIG. 17B, the probabilities (user certainty factors) of the targets (tID=2, 3) different from the target (tID=0) from which the observation information “θ=0,zu=0” is supposedly acquired are also changed. Therefore, the probability (user certainty factor) indicating which of the users the respective targets correspond to is updated accurately and efficiently.

FIG. 17C shows a result of update when the observation information “θ=1,zu=1” is observed, and shows the probability P that tID=0 is uID=0, . . . , and the probability P that tID=2 is uID=3.

Update is performed to increase the probability that tID=1 is uID=1, and accordingly, two probabilities of the probability P that tID=1 is uID=0 and the probability P that tID=1 is uID=2 are decreased.

In this processing example, for tID=0, the probability that tID=0 is uID=0 increases, the probability that tID=0 is uID=1 decreases, and the probability that tID=0 is uID=2 increases, and for tID=2, the probability that tID=2 is uID=0 increases, the probability that tID=2 is uID=1 decreases, and the probability that tID=2 is uID=2 increases. In this way, probabilities (user certainty factors) of the targets (tID=0, 2) different from the target (tID=1) from which the observation information “θ=1,zu=1” is supposedly acquired are also changed.

Although in the processing example described with reference to FIGS. 15 to 17C, update processing is performed for all target data is performed such that, under the restriction 1, that is, when any repeated xu (user identifier (UserID)) exists in P(Xu)=P(xu¹,xu², . . . ,xuⁿ), the probability is set as P(Xuₜ)=P(Xuₜ₋₁)=NG(P=0.0); otherwise, the probability is set as P(Xuₜ)=P(Xuₜ₋₁)=OK(0.0_{<}P≦1.0), the following processing may be performed without this restriction.

A state where any repeated xu (user identifier (UserID)) exists in P(Xu)=P(xu¹,xu², . . . ,xuⁿ) is deleted from target data, and processing is performed only for remaining target data.

By performing such processing, the number of states of [Xu] is reduced from kₙ to ₙPₖ, and processing efficiency can be increased.

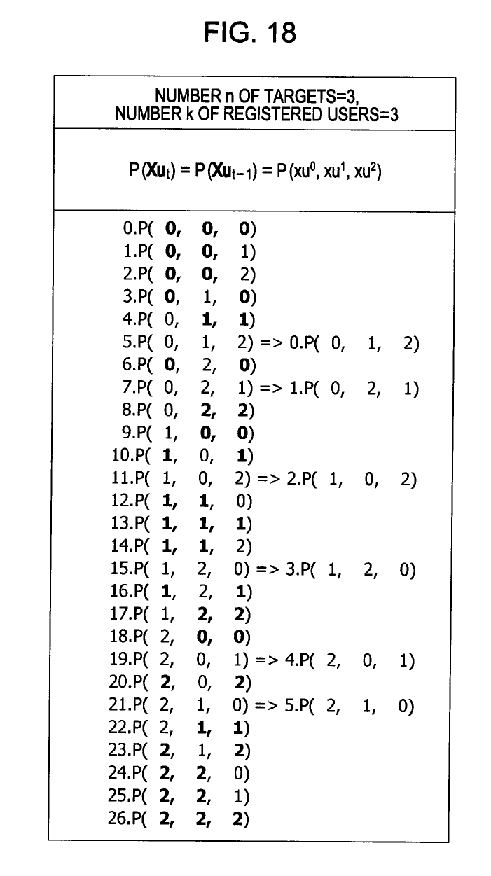

A data reduction processing example will be described with reference to FIG. 18. For example, as shown on the left side of FIG. 18, candidates of user IDs (uID=0 to 2) corresponding to three target IDs (tID=0, 1, 2) include 27 kinds of candidate data as follows.

tID0,1,2=(0,0,0) to (2,2,2)

Then, a state where any repeated xu (user identifier (UserID)) exists in the 27 kinds of candidate data [P(Xu)=P(xu¹,xu²,xu³)] is deleted from target data, so six kinds of data of 0 to 5 shown on the right side of FIG. 18 are obtained.

The sound/image integration processing unit 131 may delete candidate data set with the same user identifier (UserID) for different targets while leaving other kinds of candidate data, and may perform update processing based on event information only for the remaining candidate data.

Even when update processing is performed only for six kinds of data, the same result is achieved as described with reference to FIGS. 16A to 16C and 17A to 17C.

The overview of the exclusive user estimation method described in Japanese Patent Application No. 2008-177609 has been described with reference to FIGS. 15 to 18.

In this embodiment, processing to which this method is applied may be performed. In this case, (3) the processing for updating user certainty factors in the targets that is executed as the processing for updating the particles in Step S216 of FIG. 13A performs processing to which Equation 8 is applied. That is, in this processing, independence between targets is excluded, and processing is performed by using Equation 8 generated on the basis of Equation 5 corresponding to user identification information (UserID) described above under the restriction that the same user identifier (UserID) as user identification information is not allocated to a plurality of targets.

P(Xuₜ|θₜ,zuₜ,Xuₜ₋₁) (Equation 5)

=R×P(θₜ,zuₜ|Xuₜ)P(Xuₜ|Xuₜ)P(Xuₜ)/P(Xuₜ₋₁) (Equation 8)

The joint probability described with reference to FIGS. 15 to 18, that is, the joint probability of data of all the user IDs associated with all the targets is calculated, the joint probability is updated on the basis of an observed value input as event information, and processing for calculating user certainty factor information (uID) indicating who the targets are is performed.

As described with reference to FIGS. 17A to 17C, the probability values of a plurality of candidate data are added, that is, marginalized so as to find user identifiers corresponding to the respective targets (tID). The probability is calculated by the following equation.

P(xuⁱ)=Σₓᵤ₌ₓᵤᵢP(Xu)

In Step S217, the sound/image integration processing unit 131 generates target information (see FIG. 11) on the basis of target data set in the respective particles and outputs the target information to the processing decision unit 132. As described above, the target information includes (1) existence probabilities of targets, (2) existence positions of the targets, and (3) who the targets are (which one of uID1 to uIDk the targets are). Further, the sound/image integration processing unit 131 calculates probabilities that the respective targets (tID=cnd and 1 to n) are event occurrence sources and outputs the probabilities to the processing decision unit 132 as signal information.

As described above, the [signal information] indicating the event occurrence sources is, concerning a sound event, data indicating who spoke, that is, a [speaker] and, concerning an image event, data indicating whose face corresponds to a face included in an image.

The sound/image integration processing unit 131 calculates probabilities that the respective targets are event occurrence sources on the basis of the number of hypothesis targets of an event occurrence source set in the respective particles.

Probabilities that the respective targets (tID=1 to n) are event occurrence sources are represented as P(tID=i), where i is 1 to n. In this case, probabilities that the respective targets are event occurrence sources are calculated as P(tID=1): the number of targets allocated with tID=1/m, P(tID=2): the number of targets allocated with tID=2/m, . . . , and P(tID=n): the number of targets allocated with tID=n/m.

The sound/image integration processing unit 131 outputs information generated by this calculation processing, that is, the probabilities that the respective targets are event occurrence sources to the processing decision unit 132 as [signal information]. In this way, a frequency of a hypothesis of an event occurrence source target is set as a probability that an event occurs from any one of the targets. Processing is performed in which a ratio that an event occurrence source target hypothesis is set as noise is set as a probability that an event is noise, not one occurring from any one of the targets.

After the processing in Step S217 ends, the sound/image integration processing unit 131 returns to Step S211 and shifts to a standby state for an input of event information from the sound event detection unit 122 or the image event detection unit 112.

### [(2-3) Target Generation Process]

Next, a target generation process shown in a flowchart of FIG. 13B will be described.

The sound/image integration processing unit 131 executes processing according to the flowchart shown in FIG. 13B to set a new target in the respective particle.

First, in Step S221, an existence probability of a generation target candidate is calculated. Specifically, a frequency (ratio) of a particle forming a hypothesis of c=1 in the target generation candidate (tID=cnd) set in the respective particles is set as an existence probability of a generation target candidate.

This is information included in the target information shown in FIG. 12. That is, information concerning (1) a probability that tID=cnd exists is used. P(c=1): number of targets allocated with c=1/m

In Step S221, the sound/image integration processing unit 131 calculates a probability P(c=1) that the target generation candidate (tID=cnd) exists as follows.

P=(number of targets allocated with c=1/m)

Next, in Step S222, the existence probability P of the target generation candidate (tID=cnd) calculated in Step S221 is compared with a previously held threshold value.

That is, the existence probability P of the target generation candidate (tID=cnd) is compared with a threshold value (for example, 0.8), when the existence probability P is larger than the threshold value, it is determined that the target generation candidate (tID=cnd) exists, and processing in Step S223 is performed. When the existence probability P is smaller than the threshold value, it is determined that no target generation candidate (tID=cnd) exists, and processing in Step S223 is not performed and ends. Thereafter, processing restarts from Step S221 after a predetermined period.

When it is determined in Step S222 that the existence probability P is larger than the threshold value, in Step S223, target addition processing for setting the target generation candidate (tID=cnd) set in the respective particles as a new target n+1 (tID=n+1) is performed, and processing for adding a new target generation candidate (tID=cnd) is performed. The new target generation candidate (tID=cnd) is in the initial state.

With regard to target data of the new target n+1 (tID=n+1), target data of an old target generation candidate (tID=cnd) is set as it is.

A position distribution (a probability distribution [Gaussian distribution] of existence positions of the targets) of the new target generation candidate (tID=cnd) is set uniformly. User certainty factor information (uID) indicating who the targets are is set by the method described in Japanese Patent Application No. 2008-177609 which is an earlier application by this applicant.

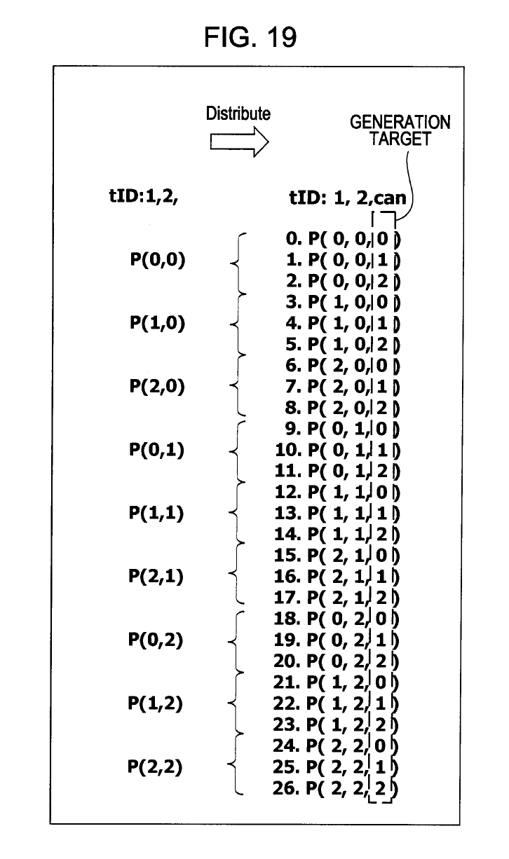

Specific processing will be described with reference to FIG. 19. When a new target is generated, data concerning the new target in a certain state increases, states for the users are allocated to increased data and the probability value is distributed to existing target data.

FIG. 19 shows a processing example where a target allocated with tID=can is newly generated and added to two targets allocated with tID=1, 2.

A left column of FIG. 19 shows nine kinds of data as target data (0,0) to (2,2) indicating candidates of uIDs corresponding to two targets allocated with tID=1, 2. Target data is further added to such target data. With this processing, 27 kinds of target data of 0 to 26 shown on the right side of FIG. 19 are set.

Distribution of probability values in the processing for increasing target data will be described. For example, three kinds of data allocated with tID=(0,0,0), (0,0,1), and (0,0,2) are generated from tID=1,2=(0,0). A probability value P set in tID=1,2=(0,0) is distributed equally to the three kinds of data [tID=(0,0,0),(0,0,1),(0,0,2)].

When processing is performed under the restriction that the same UserID is not allocated to a plurality of targets, or the like, a corresponding anterior probability or the number of states is reduced. When the sum of the probabilities of the respective kinds of target data is not [1], that is, the sum of joint probabilities is not [1], regularization processing is performed so as to perform adjustment processing such that the sum is set to [1].

As described above, when generating and adding a target, the sound/image integration processing unit 131 performs processing for allocating states for the number of users to candidate data increased due to addition of generation targets and distributing the values of the joint probabilities set for existing candidate data to increased candidate data, and further performs regularization processing for setting the sum of the joint probabilities set in all candidate data to 1.

In this way, in Step S223, UserID information of the old target generation candidate (tID=cnd) is copied to the new target n+1 (tID=n+1), and UserID information of the new target generation candidate (tID=cnd) is initialized and set.

### [Target Deletion Process]

Next, a target deletion process shown in the flowchart of FIG. 13C will be described.

The sound/image integration processing unit 131 executes processing according to the flowchart shown in FIG. 13C to delete respective targets set in the respective particles.

First, in Step S231, processing for generating a target existence hypothesis based on the time elapsed from the last update processing is performed. That is, a target existence hypothesis based on the time elapsed from the last update processing set in advance is generated for the respective targets set in the respective particles.

Specifically, processing is performed for probabilistically changing the target existence hypothesis from existence (c=1) to non-existence (c=0) on the basis of a time length for which update by an event is not made.

For example, the following probability [P] is used as a change probability [P] from existence to non-existence based on non-update duration time Δt:

P=1−exp(−a×Δt)

where Δt is time for which update by an event is not made, and a is a coefficient.

This equation is an equation for calculating the change probability [P] that the target existence hypothesis is changed from existence (c=1) to non-existence (c=0) as the time length (Δt) for which update by an event is not made becomes longer.

The sound/image integration processing unit 131 measures the time length for which the respective targets are not updated by events, and changes the target existence hypothesis from existence (c=1) to non-existence (c=0) by using the change probability [P] in response to the measured time.

In Step S232, for all the targets (tID=1 to n), excluding the target generation candidate (tID=cnd), a frequency (ratio) of a particle forming the hypothesis of existence (c=1) is calculated as the existence probability of the generation target candidate. The target generation candidate (tID=cnd) is constantly held in the respective particles and not deleted.

In Step S233, the existence probabilities calculated for the respective targets (tID=1 to n) are compared with a threshold value for deletion set in advance.

When the target existence probability is equal to or larger than the threshold value for deletion, there is nothing. Thereafter, processing restarts from Step S231, for example, after a predetermined period.

When the target existence probability is smaller than the threshold value for deletion, processing progresses to Step S234, and target deletion processing is performed.

Target deletion processing in Step S234 will be described. Data of a position distribution (a probability distribution [Gaussian distribution] of existence positions of the targets) included in target data of a target to be deleted may be deleted as it is. However, with regard to user certainty factor information (uID) indicating who the targets are, processing is performed to which the method described in Japanese Patent Application No. 2008-177609 which is an earlier application by this applicant is applied.

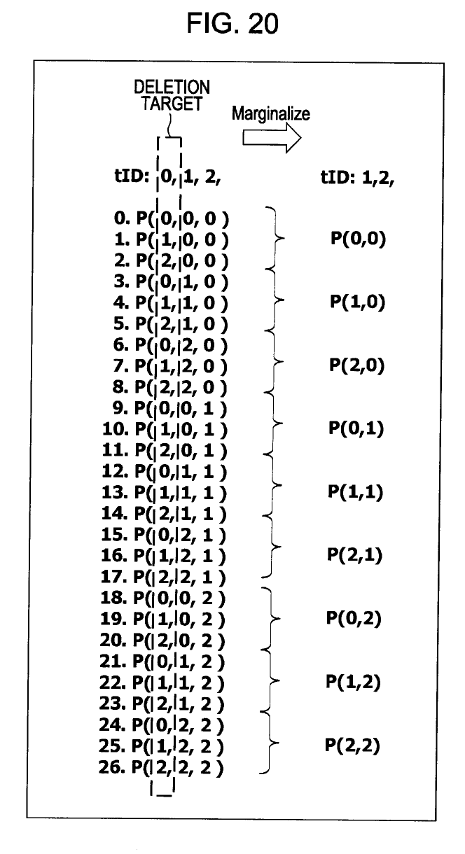

Specific processing will be described with reference to FIG. 20. In order to delete a specific target, a probability value concerning the target is marginalized. FIG. 20 shows an example where a target allocated with tID=0 is deleted from three targets allocated with tID=0, 1, and 2.

A left column of FIG. 20 shows an example where 27 kinds of target data of 0 to 26 are set as candidate data of uIDs corresponding to three targets allocated with tID=0, 1, 2. When the target 0 is deleted from these target data, as shown in a right column of FIG. 20, the target data is marginalized to nine kinds of data allocated with combinations (0,0) to (2,2) of tID=1,2. In this case, sets of data of the combinations (0,0) to (2,2) of tID=1,2 are selected from the 27 kinds of data before marginalization to generate nine kinds of data after marginalization. For example, tID=1, 2=(0,0) is generated by processing for marginalizing three kinds of data allocated with tID=(0,0,0), (1,0,0), and (2,0,0).

Distribution of probability values in the processing for deleting target data will be described. For example, one tID=1,2=(0,0) is generated from three kinds of data allocated with tID=(0,0,0), (1,0,0), and (2,0,0). The probability value P set in the three kinds of data allocated with tID=(0,0,0), (1,0,0), and (2,0,0) are set as a probability value for tID=1,2=(0,0).

As described above, to delete a target, the sound/image integration processing unit 131 executes processing for marginalizing the values of the joint probabilities set in candidate data including a target to be deleted to candidate data remaining after target deletion, and further performs regularization processing for setting the sum of the values of the joint probabilities set in all candidate data to 1.

The sound/image integration processing unit 131 executes independently the three processes shown in FIGS. 13A to 13C, that is, (a) hypothesis update process of target existence by event, (b) target generation process, and (c) target deletion process.

As described above, the sound/image integration processing unit 131 executes (a) the hypothesis update process of target existence as event driven processing which is executed in response to event occurrence.

(b) The target generation process is executed periodically for each predetermined period set in advance or is executed immediately after (a) the hypothesis update process of target existence by event.

(c) The target deletion process is executed periodically for each predetermined period set in advance.

By executing such processing, erroneous generation of a target due to erroneous event detection can be reduced, estimation that an event is noise is made possible, and determination on target generation and deletion can be executed separately from the position distribution of the targets. Therefore, accurate processing for specifying users is realized.

The invention has been described in detail with reference to the specific embodiment. However, it is obvious that those skilled in the art can make correction and substitution of the embodiment without departing from the gist of the invention. In other words, the invention has been disclosed in the form of an illustration and should not be interpreted as being limited thereto. To determine the gist of the invention, the appended claims should be taken into account.

The series of processing described in this specification can be executed by hardware, software, or a combination of hardware and software. When the processing by software is executed, it is possible to install a program having a processing sequence recorded therein in a memory of a computer incorporated in exclusive-use hardware and cause the computer to execute the program or to install the program in a general-purpose computer, which can execute various kinds of processing, and cause the general-purpose computer to execute the program. For example, the program can be recorded in a recording medium in advance. Besides installing the program from the recording medium to the computer, the program can be received through a network, such as a LAN (Local Area Network) or Internet and installed in a recording medium, such as a built-in hard disk or the like.

The various kinds of processing described in this specification are not only executed in time series according to the description but may be executed in parallel or individually according to a processing ability of an apparatus that executes the processing or when necessary. In this specification, a system has a configuration of a logical set of a plurality of apparatuses and is not limited to a system in which apparatuses having individual configurations are provided in an identical housing.

The present application contains subject matter related to that disclosed in Japanese Priority Patent Application JP 2009-009116 filed in the Japan Patent Office on Jan. 19, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a plurality of information input units inputting information including image information or sound information in a real space;
an event detection unit analyzing input information from the information input units so as to generate event information including estimated position information and estimated identification information of users present in the real space; and
an information integration processing unit setting hypothesis data regarding user existence and position information and user identification information of the users in the real space and updating and selecting hypothesis data based on the event information so as to generate analysis information including user existence and position information and user identification information of the users in the real space.

2. The information processing apparatus according to claim 1,
wherein the information integration processing unit inputs the event information generated by the event detection unit and executes particle resampling processing, to which a plurality of particles set with a plurality of targets corresponding to virtual users, so as to generate the analysis information including the user existence and position information and the user identification information of the users in the real space.

3. The information processing apparatus according to claim 1,
wherein the event detection unit generates event information including user position information having a Gaussian distribution corresponding to event occurrence sources and user certainty factor information as user identification information corresponding to the event occurrence sources, and
the information integration processing unit holds a plurality of particles set with a plurality of targets having (1) target existence hypothesis information for calculating existence probabilities of the targets, (2) probability distribution information of existence positions of the targets, and (3) user certainty factor information indicating who the targets are as target data for each of a plurality of targets corresponding to virtual users, sets target hypotheses corresponding to the event occurrence sources in the respective particles, calculates as particle weights event-target likelihoods that are similarities between target data corresponding to the target hypotheses of the respective particles and input event information so as to execute resampling processing of the particles in response to the calculated particle weights, and executes particle update processing including target data update for approximating target data corresponding to the target hypotheses of the respective particles to the input event information.

4. The information processing apparatus according to claim 3,
wherein the information integration processing unit sets as target data of the respective targets a hypothesis (c=1) with a target or a hypothesis (c=0) with no target that is the target existence hypothesis, and calculates a target existence probability [PtID(c=1)] by the following equation using the particles after the resampling processing. [PtID(c=1)]={number of targets of the same target identifier allocated with c=1}/{number of particles}

5. The information processing apparatus according to claim 4,
wherein the information integration processing unit sets at least one target generation candidate for the respective particles, compares a target existence probability of the target generation candidate with a threshold value set in advance, and when the target existence probability of the target generation candidate is larger than the threshold value, performs processing for setting the target generation candidate as a new target.

6. The information processing apparatus according to claim 5,
wherein the information integration processing unit executes processing for multiplying the event-target likelihood by a coefficient smaller than 1 so as to calculate the particle weight for a particle, in which the target generation candidate is set as the target hypothesis, at the time of the calculation processing of the particle weights.

7. The information processing apparatus according to claim 4,
wherein the information integration processing unit compares a target existence probability of each target set in the respective particles with a threshold value for deletion set in advance, and when the target existence probability is smaller than the threshold value for deletion, performs processing for deleting the relevant target.

8. The information processing apparatus according to claim 7,
wherein the information integration processing unit executes update processing for probabilistically changing the target existence hypothesis from existence (c=1) to non-existence (c=0) on the basis of a time length for which update to the event information input from the event detection unit is not made, after the update processing, compares a target existence probability of each target set in the respective particles with a threshold value for deletion set in advance, and when the target existence probability is smaller than the threshold value for deletion, performs processing for deleting the relevant target.

9. The information processing apparatus according to claim 3,
wherein the information integration processing unit executes setting processing of the target hypotheses corresponding to the event occurrence sources in the respective particles under the following restrictions:
(restriction 1) a target in which a hypothesis of target existence hypothesis is c=0 (non-existence) is not set as an event occurrence source,
(restriction 2) the same target is set as an event occurrence source for different events, and
(restriction 3) when the condition “(number of events)>(number of targets)” is established at the same time, events more than the number of targets are determined to be noise.

10. The information processing apparatus according to any one of claims 1 to 9,
wherein the information integration processing unit updates a joint probability of candidate data of the users associated with the targets on the basis of the user identification information included in the event information, and executes processing for calculating user certainty factors corresponding to the targets using the value of the updated joint probability.

11. The information processing apparatus according to claim 10,
wherein the information integration processing unit marginalizes the value of the joint probability updated on the basis of the user identification information included in the event information so as to calculate certainty factors of user identifiers corresponding to the respective targets.

12. The information processing apparatus according to claim 11,
wherein the information integration processing unit performs initial setting of the joint probability of candidate data of the users associated with the targets under a restriction that the same user identifier (UserID) is not allocated to a plurality of targets, and performs initial setting of a probability value such that the probability value of a joint probability P(Xu) of candidate data set with the same user identifier (UserID) for different targets is set to P(Xu)=0.0, and the probability of other target data is set to P(Xu)=0.0<P≦1.0.

13. An information processing method of executing information analysis processing in an information processing apparatus, the information processing method comprising the steps of:
inputting information including image information or sound information in a real space by a plurality of information input units;
generating event information including estimated position information and estimated identification information of users present in the real space by an event detection unit through analysis of the information input in the step of inputting the information;
setting hypothesis data regarding user existence and position information and user identification information of the users in the real space and updating and selecting hypothesis data based on the event information by an information integration processing unit so as to generate analysis information including user existence and position information and user identification information of the users in the real space.

14. A program for causing an information processing apparatus to execute information analysis processing, the program comprising the steps of:
inputting information including image information or sound information in a real space by a plurality of information input units;
generating event information including estimated position information and estimated identification information of users present in the real space by an event detection unit through analysis of the information input in the step of inputting the information; and
setting hypothesis data regarding user existence and position information and user identification information of the users in the real space and updating and selecting hypothesis data based on the event information by an information integration processing unit so as to generate analysis information including user existence and position information and user identification information of the users in the real space.
